(19) United States
(12) Patent Application Publication
(10) Pub. No.: US 2005/0204722 A1
(43) Pub. Date: Sep. 22, 2005

(54) Micro-combustion chamber torque transfer device

(76) Inventor: James T. Ray, Gulf Shores, AL (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(21) Appl. No.: 11/109,925

(22) Filed: Apr. 20, 2005

Related U.S. Application Data
(63) Continuation of application No. 10/748,361, filed on Dec. 30, 2003.
Application No. 10/748,361 is a continuation of application No. 10/304,200, filed on Nov. 26, 2002, now abandoned.
Application No. 10/304,200 is a continuation-in-part of application No. 10/059,507, filed on Jan. 29, 2002, now abandoned.
Application No. 10/059,507 is a continuation-in-part of application No. 09/176,481, filed on Oct. 21, 1998, now abandoned.
Application No. 09/176,481 is a continuation-in-part of application No. 08/955,590, filed on Oct. 22, 1997, now abandoned.

(51) Int. Cl. F02C 3/16

(52) U.S. Cl. 60/39.35

(57) ABSTRACT

A torque transferring device is provided having a rotating drive shaft and planetary gear sets that are linked to a rotating chamber, keyed to the drive shaft, to turbomachinery within the chamber. Fluid is fed to the chamber through an axial passage in the drive shaft and is compressed by a number of mechanisms, including set of pump blades, turbine and reaction blades initially driven by the drive shaft and its starter motor. Bubbles within the fluid are subjected to high pressures causing combustion to occur within the bubbles. Additional pressure created by the combustion of the bubbles drives the fluid to exert a torque on the drive shaft through the gearing mechanism, thereby generating power.

### CROSS-REFERENCE TO RELATED APPLICATIONS

This is a continuation of U.S. patent application Ser. No. 10/748,361, filed Dec. 30, 2003, which is a continuation of U.S. patent application Ser. No. 10/3047,200, filed Nov. 26, 2002, which is a continuation-in-part of U.S. patent application Ser. No. 10/059,507, filed Jan. 29, 2002, which is a continuation-in-part of U.S. patent application Ser. No. 09/176,481 Oct. 21, 1998, which is a continuation-in-part of U.S. patent application Ser. No. 08/955,590, filed Oct. 22, 1997, all of which are incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates generally to an engine that produces energy through a process known as Cavitation and Associated Bubble Dynamics, and specifically to a method and apparatus for a combustion engine that uses bubbles within a fluid as the combustion chamber and for providing the combustion thereof. More particularly, the present invention relates to combustion-type engines that require compression and not spark ignition as part of the combustion process. Even more particularly, the present invention relates to an improved combustion engine that uses a fuel source in the form of a combustible fluid material having been mechanically influenced to provide gas bubbles that are rather small and which bubbles contain a combination of oxygen, water and the burnable fuel matter in vapor form. The term “micro-combustion chamber” as used herein is referring to such small gas bubbles. The bubble combustion process creates an expansion that produces force for driving a pair of rotating members within the chamber. These members have vanes that are so positioned that expansion of the combusting matter contained within the bubbles causes these two particular rotating members to rotate in opposite directions relative to one another, therefore, generating torque that is transmitted to a shaft through a gearing arrangement.

2. General Background of the Invention

Combustion engines are well known devices for powering vehicles, generators and other types of machinery. Some engines require a spark ignition. Some engines such as diesel type engines only require compression for combustion to occur.

Combustion diesel engines use one or more reciprocating pistons to elevate the pressure within a corresponding cylinder in order to achieve combustion.

Among the disadvantages of such engines are inefficiencies caused by heat losses, frictional losses and unharnessed (wasted) work due to the reciprocation of each piston. For example, in a eight cylinder engine, only one cylinder is producing power at any given moment while all eight cylinders are constantly contributing to frictional losses. The reciprocation of each piston also results in unwanted vibration and noise. In addition, due to the relatively low combustion temperatures in such reciprocating piston engines, excessive pollutants such as particulates and carbon monoxide are produced by these engines.

Furthermore, reciprocating piston engines require refined fuel such as gasoline made from cracking of oil that is performed in refineries and costly to produce. Such engines also require complex fuel injection or carbureation systems, camshafts, electrical systems and cooling systems that can be expensive and difficult to maintain.

Accordingly, there is a need for more efficient, smoother running and lower emission alternative fuel engines for use in vehicles, generators, and other machinery.

### BRIEF SUMMARY OF THE INVENTION

It is an object of the present invention to overcome one or more of the problems described above.

In accordance with one aspect of the present invention, a method for increasing the pressure of a fluid in a combustion engine is provided. The method comprises the steps of: creating a bubble of gaseous material within a fluid; elevating the pressure within the bubble to a level such that the temperature inside the bubble reaches a flash point; and obtaining combustion within the bubble.

In accordance with another aspect of the present invention, a method for generating torque on a rotating shaft is provided. The method comprises the steps of: providing a chamber connected to the shaft for rotation therewith, the chamber having a fluid inlet and a fluid outlet; feeding a fluid into the chamber, the fluid including at least one gaseous bubble; elevating the pressure within the bubble to a level such that the temperature inside the bubble reaches a flash point; and producing combustion within the bubble to elevate the pressure of fluid in the chamber, thereby driving fluid through certain member vanes producing torque and then out through the chamber fluid outlet.

In accordance with yet another aspect of the present invention, a combustion engine comprises a pump, a fluid reservoir, a drive shaft having a passage therein, and a high pressure chamber fixedly attached to the drive shaft for rotation therewith.

The high pressure chamber contains a compression drive unit including one or more compression drives blades fixedly attached on the drive shaft, a combustion channel unit rotatably journalled on the drive shaft and containing one or more combustion channels, an impulse drive unit including one or more impulse drives blades rotatable journalled on the drive shaft, and a planetary gear set.

The planetary gear set includes a ring gear fixedly attached to one of two end plates that are fixedly attached to the drive shaft for rotation therewith, a sun gear fixedly attached to the impulse drive unit for rotation therewith, and one or more planet gears. Each planet gear is rotatable journalled on the combustion channel unit at a location radially intermediate the sun gear and the ring gear and in meshing engagement with the sun gear and the ring gear.

Therefore, the present invention provides a combustion engine of improved configuration that burns matter contained within small bubbles of a fluid stream, combust these bubbles and produces torque on the shaft.

The apparatus includes a housing with an interior for containing fluid in a reservoir section. A rotating drive shaft is mounted in the housing and includes a portion that extends inside the housing interior above the fluid reservoir.

A chamber is mounted on the drive shaft within the housing interior for rotation therewith.

The chamber includes a power generating system or unit that is positioned within the chamber interior for rotating the drive shaft when fluid flow and bubble combustion take place within the chamber interior. Fluid is provided to the power generating unit via circulation conduit that supplies fluid from the reservoir to the chamber power generating system preferably via a bore that extends longitudinally through the drive shaft and then transversely through a port and into the chamber.

Within the chamber, the fluid follows a circuitous path through various rotating and non-rotating parts. These parts include at least three rotating members each with vanes thereon, the respective vanes being closely positioned with a small gap therebetween so that when the rotating members are caused to rotate in a given rotational direction, the bubbles are compressed and combustion of the material in the small bubbles occurs and torque is produced.

A starter is used to preliminarily rotate the shaft and initiate fluid flow. The fluid flow centrifugally causes the respective internal chamber members to rotate. The respective rotating members are so configured and geared, that when they are rotated, they will rotate at different speeds and in relative opposite rotational directions due to the force cause by the fluid flow, however, they will try to rotate in the same direction due to the force cause by the gearing. These conflicting forces configure a fluid flow design that provides a high pressure zone and produces bubble compression. Bubble combustion occurs when two things happen. First, the bubble critical compression produces a sufficiently high temperature in the bubble nucleus to initiate burn. Second, the bubble pressure is lowered. These two steps define one complete combustion cycle. The bubble high pressure and low pressure points occur at the interface between two of the rotating members. The bubble combustion occurs just before the bubble leaves the compression pressure zone. The bubble combustion will apply force in two different fields of direction. This combustion process produces a net expansion force that causes the blades of the two interfacing members to separate and, thereby, causes the two interfacing members proper to rotate in opposite rotational directions.

A gear mechanism is used to transfer the rotary power from both of the two rotating members to the drive shaft.

It is to be understood that both the foregoing generally description and the following detailed description are exemplary and explanatory only and are not restrictive of the invention as claimed. Additional features and advances of the invention will be set forth in the description which follows, and in part will be apparent from the description or may be learned by practice of the invention. The objectives and other advantages of the invention will be realized and attained by the apparatus and method particularly pointed out in the written description and claims hereof, as well as, the appended drawings.

### BRIEF DESCRIPTION OF THE DRAWINGS

For a further understanding of the nature, objects, and advantages of the present invention, reference should be made to the following detailed description and read in conjunction with the following drawings, wherein like reference numerals denote like elements and wherein:

FIG. 1 is a perspective view of the preferred embodiment of the apparatus of the present invention;

FIG. 2 is another perspective view of the preferred embodiment of the apparatus of the present invention;

FIG. 3 is a partially cutaway front elevational view of the preferred embodiment of the apparatus of the present invention;

FIG. 4 is a partial top view of the preferred embodiment of the apparatus of the present invention illustrating the chamber, flinger plate, and drive shaft;

FIG. 5 is a sectional view taken along lines 5-5 of FIG. 4; FIG. 6 is a sectional view taken along lines 6-6 of FIG. 5;

FIG. 7 is a sectional view taken along lines 7-7 of FIG. 5;

FIG. 8 is a sectional view taken along lines 8-8 of FIG. 5;

FIG. 9 is a fragmentary enlarged view of the vane and combustion interface, an enlargement of a portion of FIG. 7 that is encircled in phantom lines;

FIG. 10 is a partial perspective exploded view of the preferred embodiment of the apparatus of the present invention illustrating the combustion channels unit and impulse drive unit portions thereof;

FIG. 11 is a perspective fragmentary view of the preferred embodiment of the apparatus of the present invention illustrating the compression drive unit;

FIG. 12 is a perspective exploded partially cutaway view of the preferred embodiment of the apparatus of the present invention illustrating the working parts mounted on the drive shaft;

FIG. 13 is a perspective view of a second embodiment of the apparatus of the present invention;

FIG. 14 is another perspective view of the second embodiment of the apparatus of the present invention;

FIG. 15 is a partially cut away front elevational view of the second embodiment of the apparatus of the present invention;

FIG. 16 is a partial top view of the second embodiment of the apparatus of the present invention illustrating the chamber, flinger plate, and drive shaft; FIG. 17 is a sectional view taken along lines 17-17 of FIG. 16;

FIG. 18 is a sectional view taken along lines 18-18 of FIG. 17;

FIG. 19 is a sectional view taken along lines 19-19 of FIG. 17;

FIG. 20 is a sectional view taken along lines 20-20 of FIG. 17;

FIG. 21 is a sectional view taken along lines 21-21 of FIG. 17;

FIG. 22 is a sectional view taken along lines 22-22 of FIG. 17;

FIG. 23 is an enlarged fragmentary view of the second embodiment of the apparatus of the present invention showing an enlargement of a portion of FIG. 20 and combustion that takes place at an interface between the torque drive blades and combustion channel blades;

FIG. 24 is a partial exploded perspective view of the second embodiment of the apparatus of the present invention;

FIG. 25 is a fragmentary sectional elevational view of the alternate embodiment of the apparatus of the present invention illustrating fluid flow and combustion at the interface between torque drive blades and combustion channel blades;

FIG. 26 is a perspective view of the third embodiment of the apparatus of the present invention;

FIG. 27 is another perspective view of the third embodiment of the apparatus of the present invention;

FIG. 28 is a partially cut away front elevation view of the third embodiment of the apparatus of the present invention;

FIG. 29 is a schematic view of the third embodiment of the apparatus of the present invention;

FIG. 30 is a partial, sectional view of the third embodiment of the apparatus of the present invention;

FIG. 31 is a sectional view taken along lines 31-31 of FIG. 30;

FIG. 32 is a sectional view taken along lines 32-32 of FIG. 30;

FIGS. 33-33A are sectionals view taken along lines 33-33 of FIG. 30, FIG. 33A being a partial enlargement of FIG. 33;

FIG. 34 is an exploded perspective view of the third embodiment of the apparatus of the present invention;

FIG. 35 is a sectional view of a fourth embodiment of the apparatus of the present invention;

FIG. 36 is a sectional view taken along lines 36-36 in FIG. 35;

FIG. 37 is a perspective view of a fifth embodiment of the apparatus of the present invention;

FIG. 38 is another perspective view of the fifth embodiment of the apparatus of the present invention;

FIG. 39 is a partial sectional elevation view of the fifth embodiment of the apparatus of the present invention taken along lines 39-39 of FIG. 1;

FIG. 40 is a fragmentary elevation view of the fifth embodiment of the apparatus of the present invention;

FIG. 41 is a sectional view of the fifth embodiment of the apparatus of the present invention;

FIG. 42 is a sectional view taken along lines 42-42 of FIG. 41.

FIG. 43 is a partial sectional view of the fifth embodiment of the apparatus of the present invention;

FIG. 44 is a fragmentary view of the fifth embodiment of the apparatus of the present invention;

FIG. 45 is a sectional view taken along lines 45-45 of FIG. 41;

FIG. 46 is a sectional view taken along lines 46-46 of FIG. 41; and

FIG. 47 is an exploded, partial perspective view of the fifth embodiment of the apparatus of the present invention.

### DETAILED DESCRIPTION OF THE INVENTION

FIGS. 1-4 show generally the preferred embodiment of the apparatus of the present invention designated generally by the numeral 10 in FIGS. 1, 2, and 3. Combustion engine 10 has an enlarged housing 11 with an interior 14. The housing 11 is comprised of upper and lower sections including a lower reservoir section 12 and an upper cover section 13.

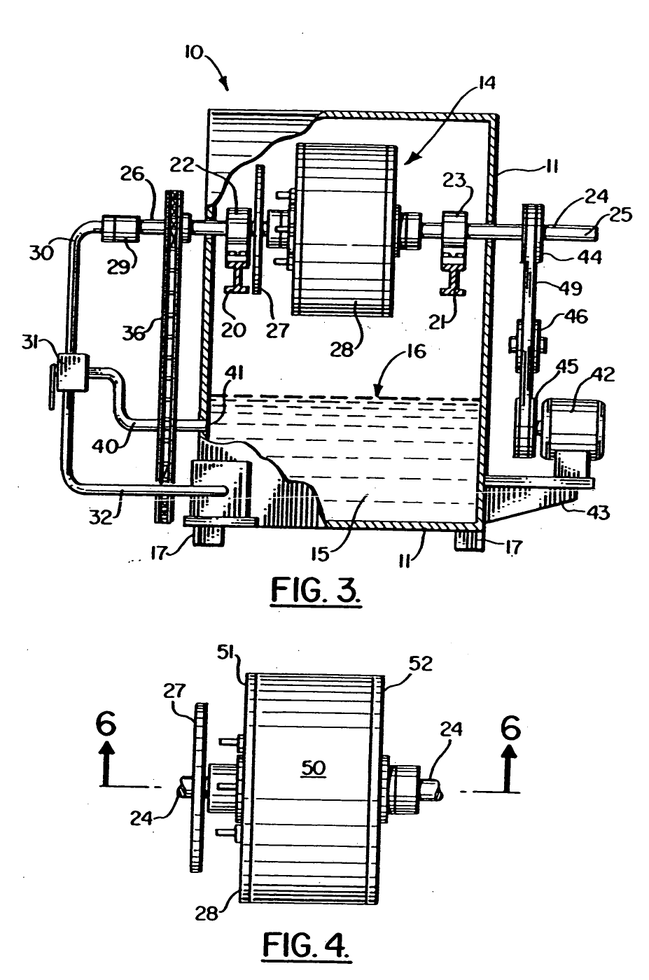

Fluid 15 is contained in the lower portion of reservoir section 12 as shown in FIG. 3, the fluid 15 having a fluid level 16 that is well below chamber 28 and drive shaft 24. The fluid can be most any combustible fluid including automatic transmission fluid, hydraulic fluid, vegetable oil, corn oil, peanut oil, for example. A plurality of feet 17 can be used to anchor housing 11 to a pedestal, mount, concrete base, or like structural support. A pair of sealing mating flanges 18, 19 can be provided respectively on housing sections 11, 12 to form a closure and seal that prevents leakage during use.

A pair of spaced apart transversely extending beams 20, 21 such as the I-beams shown, can be welded to housing reservoir section 12 providing structural support for supporting drive shaft 24 and its bearings 22, 23. The drive shaft 24 is to be driven by a rotating member contained within chamber 28 as will be described more fully hereinafter. For reference purposes, drive shaft 24 has a pair of end portions including starter end portion 25 and fluid inlet end portion 26. Drive shaft 24 carries chamber 28 and flinger plate 27.

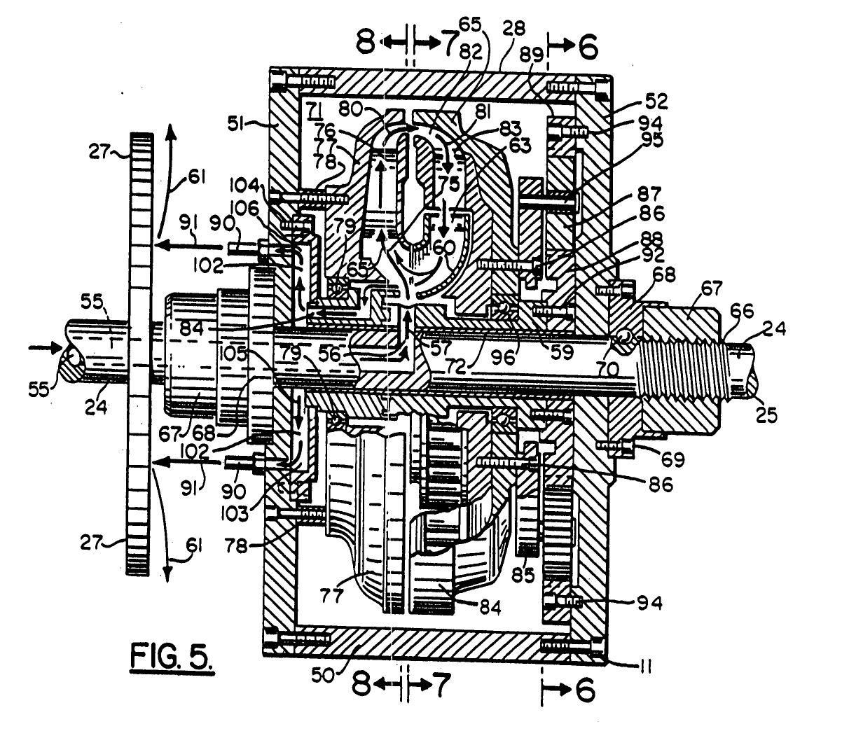

In FIG. 4, the chamber 28 including its cylindrically-shaped wall portion 50 and its circular end walls 51, 52 is mounted integrally to and rotates with shaft 24. Similarly, flinger plate 27 is connected integrally to and rotates with shaft 24. The flinger plate 27 is used to aerate the liquid 15 after it has been transmitted to chamber 28 and exists therefrom through a plurality of jets 90 (see FIG. 5). The fluid exits via jets 90 and 15 strikes the flinger plate 27 which is rotating with shaft 24 during use. Plate 27 throws the fluid 15 radially away from plate 27 due to the centrifugal force of plate 27 as it rotates with shaft 24.

The circulation of fluid 15 through the apparatus 10 begins at reservoir section 12 wherein a volume of liquid 15 is contained below fluid surface 16 as shown. The complete travel of fluid 15 through the apparatus 10 is completed when fluid exits chamber 28 and strikes flinger plate 27, being thrown off flinger plate 27 as shown by arrow 61 in FIG. 5 to strike housing 11 and then drain to reservoir section 12 of housing 11. This exiting of fluid 15 from chamber 28 so that it strikes flinger plate 27 creates very small bubbles in fluid 15 that will be the subject of combustion when that aerated fluid 15 again enters chamber 28 via shaft 24 bore 55 as will be described more fully herein.

In FIGS. 1-3, fluid 15 from reservoir section 12 is first pumped with pump 33 to flow outlet line 32. This is accomplished initially with a starter motor 42 that rotates shaft 24. The rotating shaft 24 then rotates pump 33 using power take off 36.

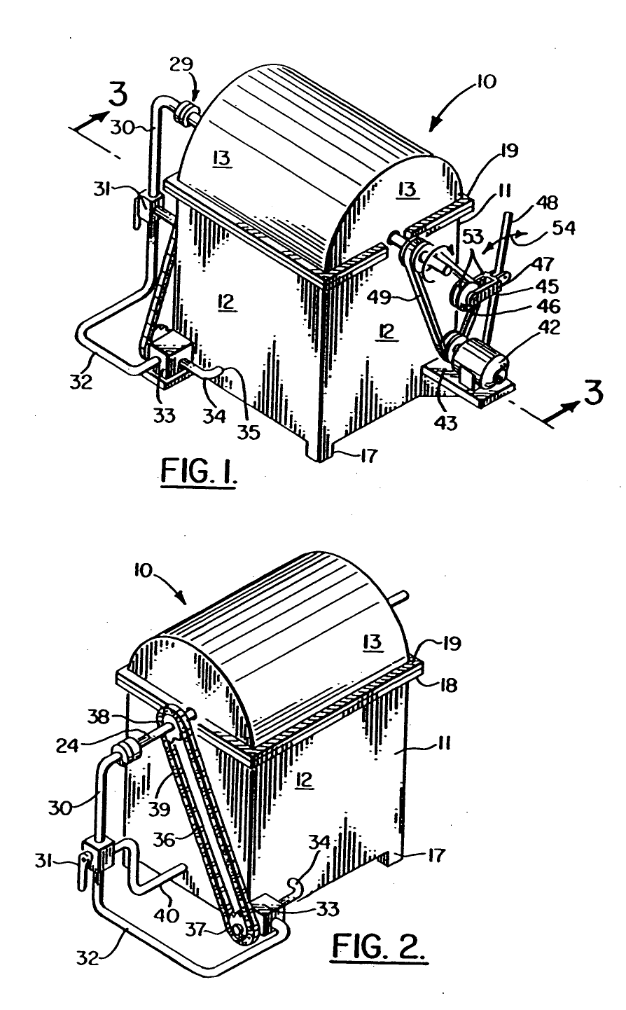

Fluid is transferred from reservoir section 12 via outlet port 35 to suction line 34. Fluid flows from suction line 34 to pump 33 and then to flow outlet line 32. The fluid then flows through control valve 31 to flow inlet line 30. A bypass line 40 enables a user to divert flow at control valve 31 so that only a desired volume of fluid enters flow inlet line 30 and hollow bore 55 of shaft 24 at rotary coupling 29. Once fluid 15 is transmitted to bore 55, it flows into the interior 71 of chamber 28 for use as a source of combustion as will be described more fully hereinafter. Shaft 24 is connected to flow inlet line 30 with a rotary fluid coupling 29. Power take off 36 can be in the form of a pair of sprockets 37, 38 connected to pump 33 and drive shaft 24 respectively as shown in FIG. 2. A chain drive 39 can be used to connect the two sprockets 37, 38. Rotation of the drive shaft 24 thus effects a rotation of the pump 33 so that fluid will be pumped from reservoir section 12 of housing 11 via lines 30, 32 to bore 53 of shaft 24 once starter motor 42 is activated. If fluid 15 is to be bypassed using bypass 40, it is simply returned to reservoir section 12 via bypass line 40 and port 41.

Starter motor 42 can be an electric or combustion engine for example. The motor 42 is mounted upon motor mount 43. Shaft 24 provides a sheave 44. Motor drive 42 has a sheave 45. A sheave 46 is provided on clutch 53. The sheaves 44, 45, 46 are interconnected with drive belt 49. Clutch 53 also includes a sheave support 47 and a lever 48 that is pivotally attached to mount 43 and movable as shown by arrow 54 in FIG. 1.

In order to initiate operation, fluid is pumped using pump 33 and motor 42 from reservoir 15 into bore 55 of shaft 24 and then into transverse port 56. Fluid 15 is picked up by compression drive blades 76 and is centrifugally thrown around and across to combustion channel blades 83 (see arrows 80, 81). Fluid at arrow 81 strikes combustion channel blades 83 and rotates them clockwise in relation to starter 24 end of drive shaft 24. Continued fluid flow in the direction of arrow 81 causes fluid 15 to hit vanes 63 of impulse drive unit 60, rotating unit 60 counter clockwise in relation to the starter end 24 of shaft 24.

Fluid then returns along the impulse drive unit 60 to exit channels 101 (see arrow 84). Since there are only two channels 101, some fluid 15 recirculates to blades 76. Fluid exiting channels 101 enters reservoir 102 and then exits chamber 28 at outlet jets 90 to strike flinger plate 27. At plate 27 the liquid 15 is thrown by centrifugal force to housing 11 where it drains into reservoir section 12.

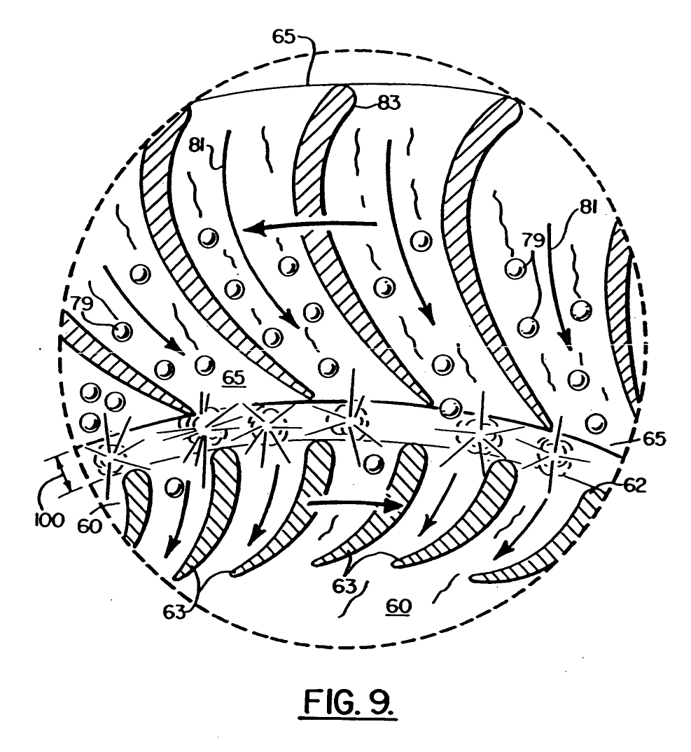

In order to start the engine 10, the user cranks the starter motor 42 until drive shaft 24 rotates to a desired RPM. On an actual prototype apparatus 10, the starter motor 42 is cranked until the drive shaft 24 reaches about 1600 RPM's. At that time, the small air bubbles (containing oxygen and vapor from the fluid 15) begin to burn at the combustion site designated as 62 in FIG. 9 so that the shaft 26 is driven. When the matter in these bubbles begins to burn, the bubbles expand. In FIG. 9, vanes 63, 83 on two rotary parts 60, 65 capture this expansion. The vanes 63, 83 are so positioned and shaped that the rotary parts 60, 65 rotate in opposite directions. These two rotary parts are the impulse drive unit 60 and the combustion channels unit 65. These rotary parts 60 and 65 are part of a mechanism contained within chamber 28.

The inner workings of chamber 28 are shown more particularly in FIGS. 4-8. Shaft 24 supports chamber 28. The chamber 28 end plates 51, 52 are rigidly fastened to shaft 24 and rotate therewith. In FIG. 5, the starter end 25 of shaft 24 has an externally threaded portion 66 that accepts lock nut 67. Lock ring 68 bolts to end plate 52 at bolted connections 69. Key 70 locks lock ring 68 and thus end plate 52 to shaft 24. Such a lock ring 68 and lock nut 67 arrangement is used to affix end plate 51 to the fluid inlet end portion 26 of shaft 24.

The combination of end plates 51, 52 and cylindrical canister 50 define an enclosure with an interior 71 to which fluid is transmitted during use for combustion. Fluid that enters shaft bore 55 passes through transverse passageway 56 in the direction of arrow 57 to interior 71 of chamber 28. Bearing 72 is mounted on shaft 24 in between end plates 51, 52. Sleeve 73 is mounted on bearing 72. Transverse openings through shaft 24, bearing 72 and sleeve 73 define transverse flow passage 56.

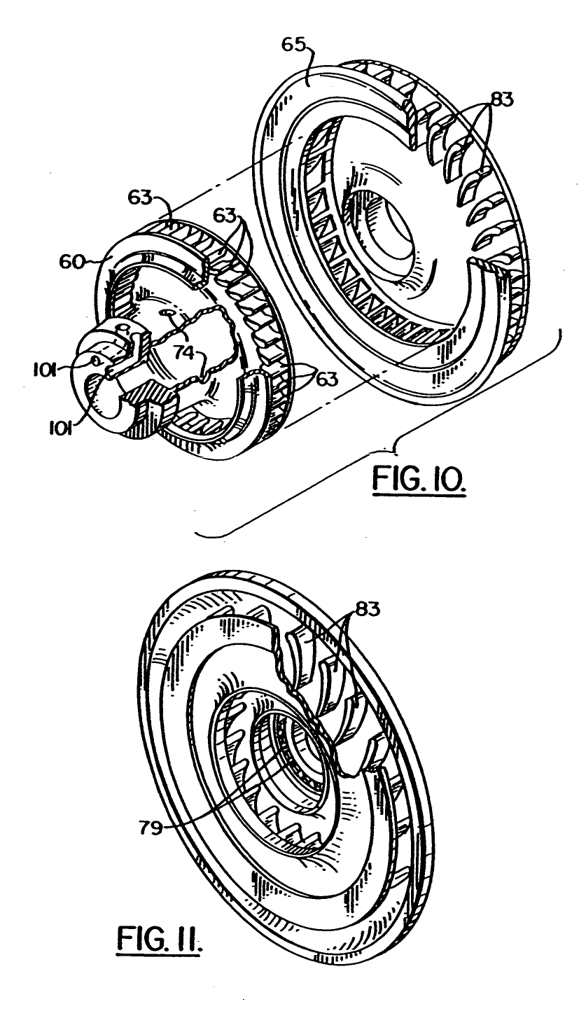

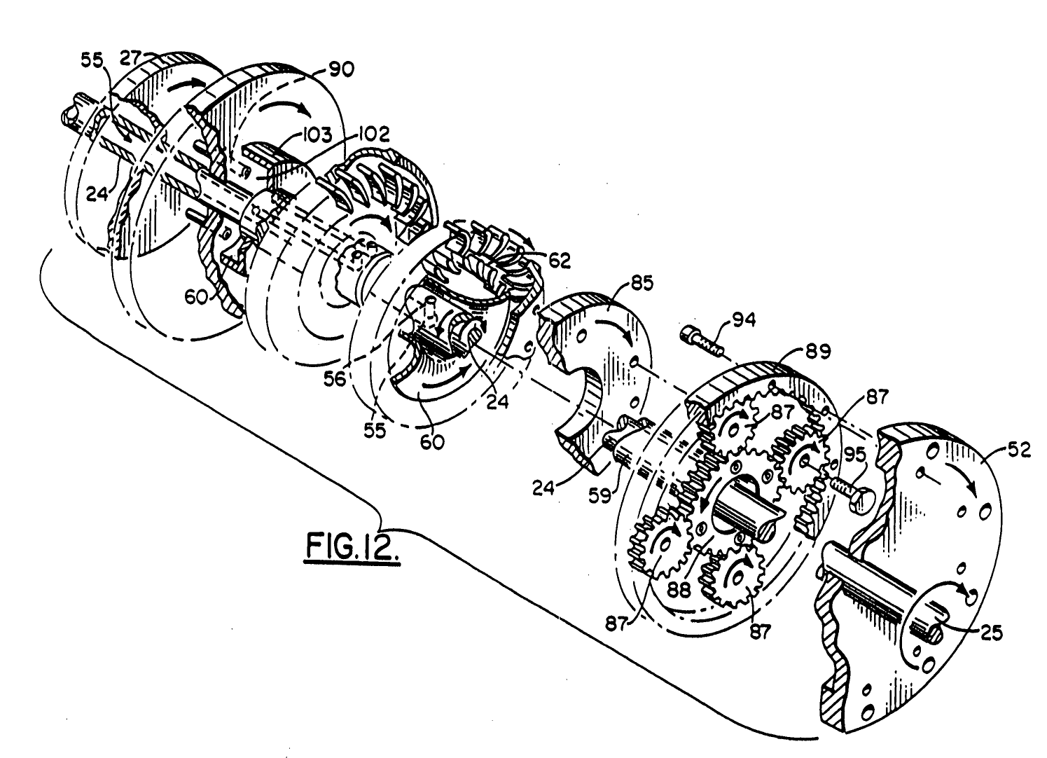

Impulse drive unit 60 (FIGS. 5 and 10) is rotatably mounted with respect to shaft 24, being journalled on shaft 24 at transverse passageway 56. A plurality of preferably four radially extending flow outlet openings 74 enable flow to continue on a path extending radially away from shaft 24 as shown by arrows 75 in FIG. 5. The flow the passes through blades or vanes 76 of compression drive unit 77, a part that is affixed to end plate 51 at bolted connections 78. Bearings 79 can form a load transfer interface between compression drive unit 77 and sleeve 73. The fluid 15 passes over vanes 76 of compression drive unit 77 and radially beyond vanes 76 as shown by arrow 80 in FIG. 5 due to centrifugal force as shaft 24 and chamber 28 are rotated (initially by starter motor 42). Bearing 96 rotatably mounts compression channels unit 65 to sleeve 59.

Fluid 15 travels from compression drive blades 76 across cavity 82 in the direction of arrows 80, 81 to combustion channel blades 83 of combustion channels unit 65. Continued fluid flow brings fluid 15 to and through the blades or vanes 63 of impulse drive unit 60.

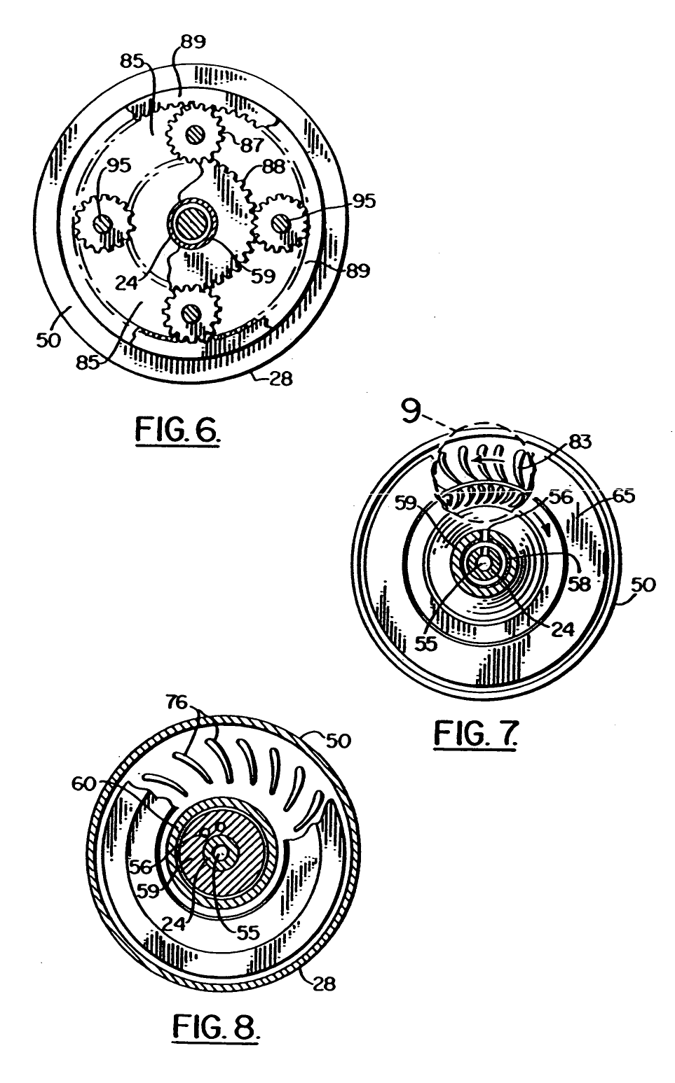

Combustion occurs at the interface of combustion channel blades 83 and the impulse drive blades 63. These respective blades 63 and 83 are very close together (see FIGS. 7 and 9) so that severe turbulence causes rapid compression of these bubbles 79 and combustion of their contents (fluid 15 vapor and oxygen). The combustion of the matter within these bubbles 79 causes rapid expansion. This combination of expansion and the shapes of the blades 63, 83 drives the impulse drive unit 60 and combustion channel unit in opposite rotary directions (see FIG. 9).

When viewed from the starter end 25 of shaft 24 (see FIGS. 7 and 9) the impulse drive unit 60 rotates counter clockwise and the combustion channels unit 65 rotates counter clockwise. A mix of incoming fluid (arrow 76 in FIG. 5) and outgoing fluid (arrow 84 in FIG. 5) occurs at 85 before fluid 15 exits chamber 28 at fluid outlet jets 90 in plate 51 as shown by arrows 91.

Combustion channel unit 65 is bolted to combustion channel inner housing 84 and rotates with it. This assembly of unit 65 and housing 84 are bolted to planet gear mounting plate 85 and rotates therewith. Bolted connection 86 affixes planet gear mounting plate 85, combustion unit inner housing 84 and combustion channels unit 65 together.

A plurality (preferably four) planet gears 87 are rotatably mounted ninety degrees (90°) apart to planet gear mounting plate at rotary bushings 95. Ring gear 89 is bolted at connections 94 to end plate 52 and rotates therewith.

When viewed from the starter end 25 of shaft 24, the planet gear mounting plate 85 rotates clockwise (see FIG. 12) during combustion as do the combustion channel unit 65 and combustion channel inner housing 84 all bolted together as an assembly. However, because of the planetary gearing 87, 88, 89 these parts 65, 84, 85 rotate slower than shaft 24.

Sun gear 88 is mounted to impulse drive unit 63 with sleeve 59. Sun gear 88 can connect to sleeve 59 at bolted connections 92. A splined connection 93 can connect sleeve 59 to impulse drive unit 63. Thus, combustion at the impulse drive unit blades 63 (see FIG. 9) rotates the impulse drive unit 60 counter clockwise (relative to shaft 24 starter end 25) and sleeve 59 connects that counter clockwise rotation to sun gear 88.

Power to drive shaft 24 is generated as follows. Rotational directions are in relation to the starter end 25 of shaft 24 (see FIG. 12). Impulse drive unit 60 and combustion channels unit 65 rotate in opposite rotational directions once the starter motor generates rotation of shaft 24 and initiates fluid flow to a rotational speed of about 1600 rpm. Fluid pumped with pump 33 enters shaft bore 57 and chamber 28 interior via transverse passageway 56. Fluid 15 flow travels over blades 76 of compression drive unit 77 (see arrows 79, 80, 81) to the interface between blades 63 and 83 (see FIG. 9). Initially, fluid flow generated by pump 33 causes fluid 15 flow in the direction of arrows 81 (FIGS. 5, 8, and 9) to rotate impulse drive unit 60 in a counter clockwise direction and combustion channels unit 65 in a clockwise direction. Once rotational speed of shaft 24 reaches about 1600 rpm, the material in bubbles 79 in between blades 63 of impulse drive unit 60 and blades 83 of combustion channel unit 65 burns.

Compression of the bubbles 79 at this interface 62 between blades 63 and 83 causes combustion of the fluid vapor-oxygen mixture inside each bubble 79 much in the same way that compression causes ignition and combustion in diesel type engines without the necessity of a spark. In FIG. 9, the gap 100 in between blades 63 and 83 is very small, being about 40 mm.

Fluid 15 return to reservoir section 12 is via flow channels 101 in drive unit 60 and then to annular reservoir 102 that communicates with jets 90. Reservoir 102 is defined by generally cylindrically shaped receptacle 103 bolted at 104 to end wall 51. A loose connection is made at 105 in between receptacle 103 and impulse drive unit 60. Arrows 106 show fluid flow through impulse drive unit 60 flow channels 101 to reservoir 102.

If impulse drive unit 60 and sun gear 88 rotate counter clockwise and the planet gears 87 (and the attached planet gear mounting plate 85, combustion unit inner housing 84 and combustion channels unit 65) rotate clockwise, the ring gear 89 and right end plate 52 (mounted rigidly to shaft 24) rotate clockwise at a faster rotary rate than impulse drive unit 60 and sun gear 88 due to the planetary gear (87, 88, 89) arrangement. This can be a 3-1 gear ratio.

The engine 10 of the present invention is very clean, not having an “exhaust” of any appreciable amount. Residue of combustion is simply left behind in the fluid 15.

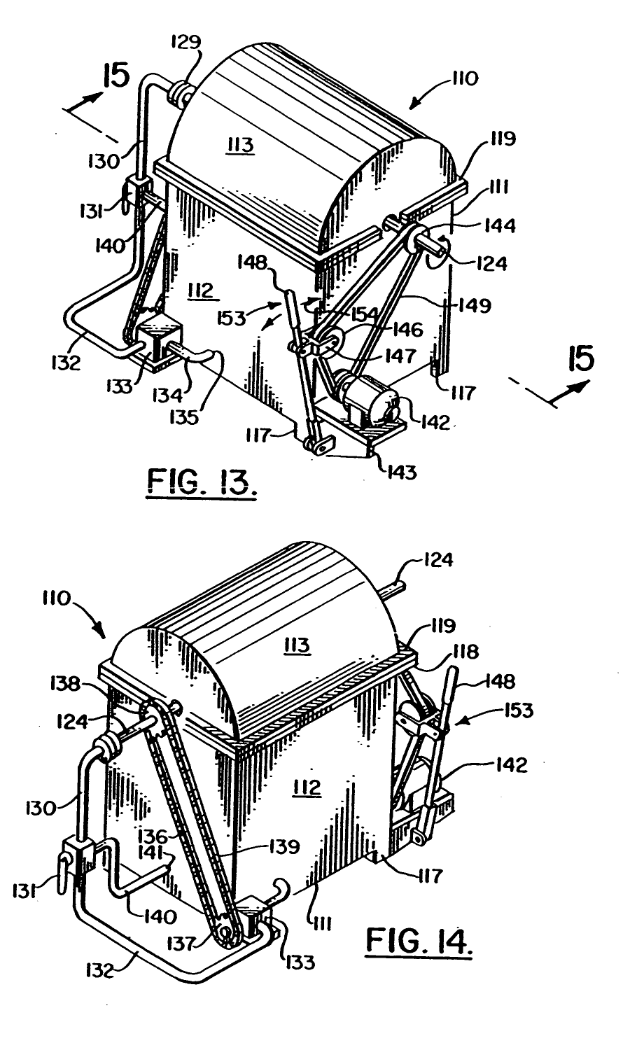

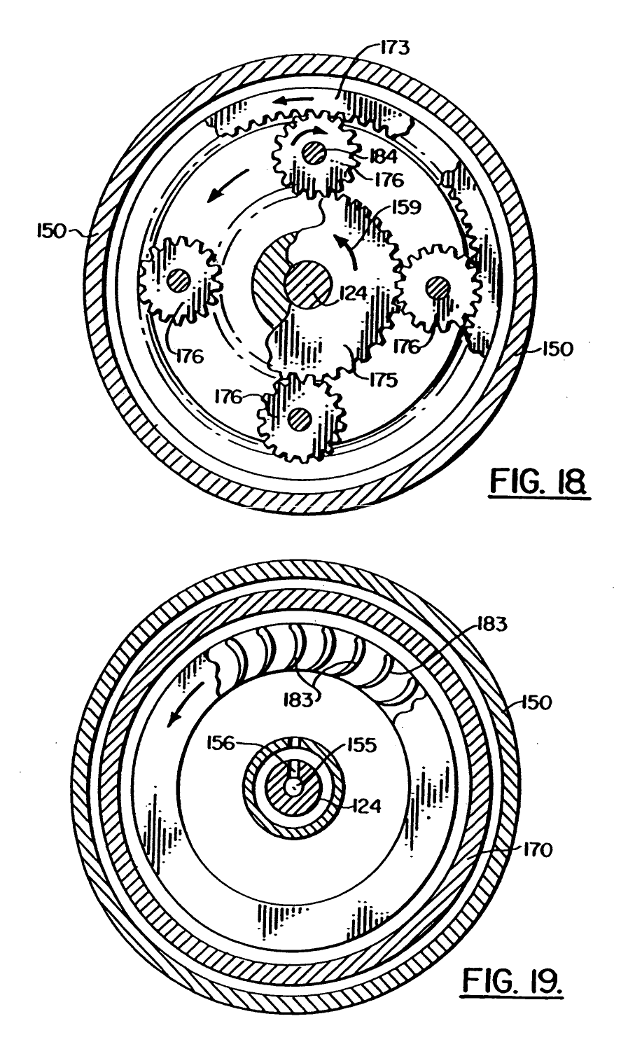

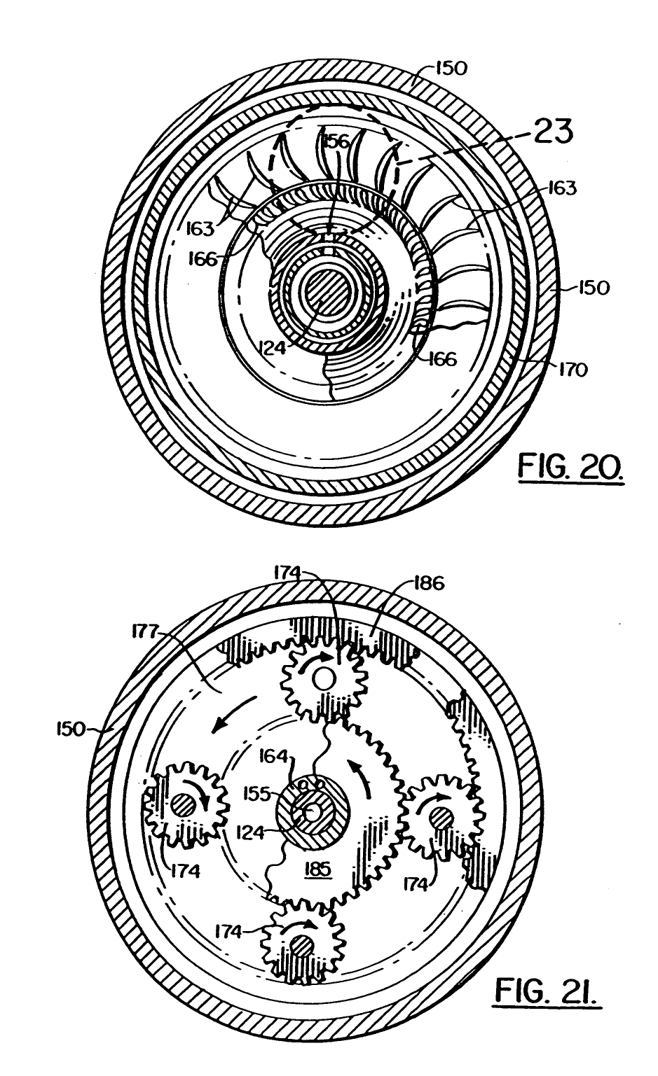

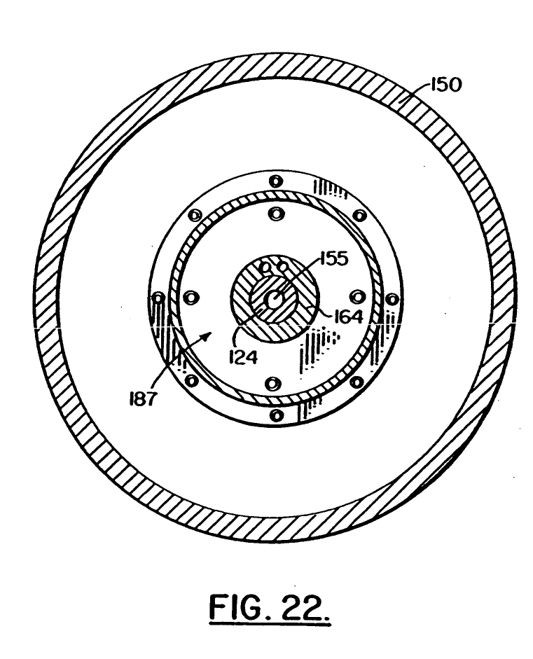

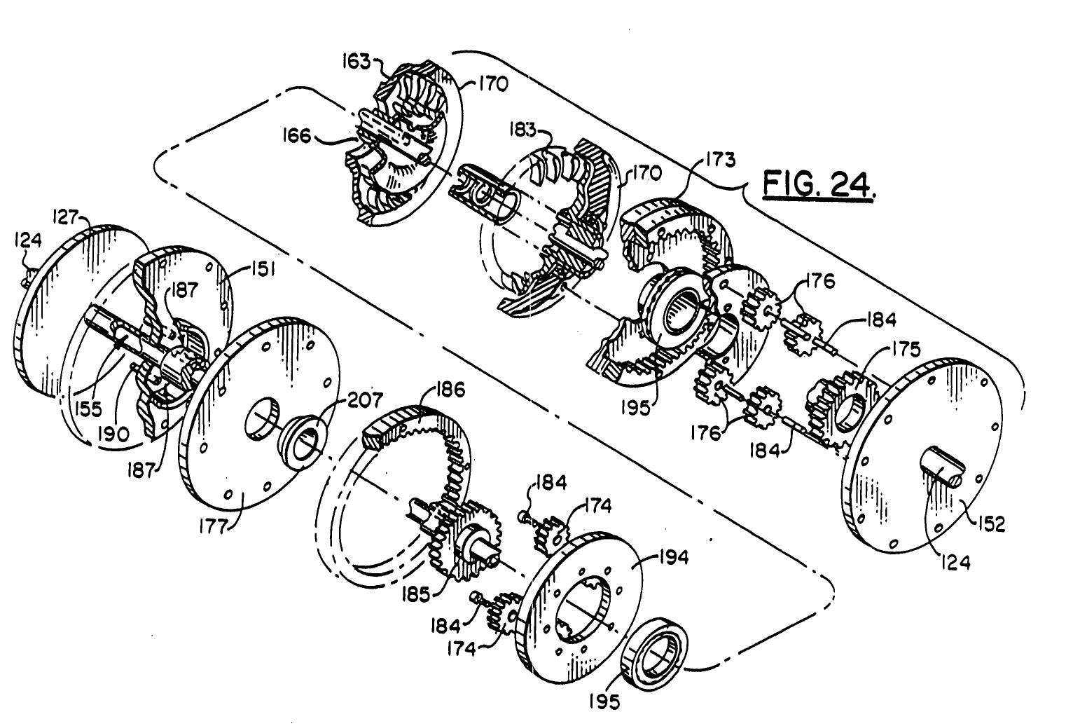

FIGS. 13-25 show a second embodiment of the apparatus of the present invention designated generally by the numeral 110 in FIGS. 13, 14, and 15. Combustion engine 110 has an enlarged housing 111 with an interior 114. The housing 111 is comprised of upper and lower sections including a lower reservoir section 112 and an upper cover section 113.

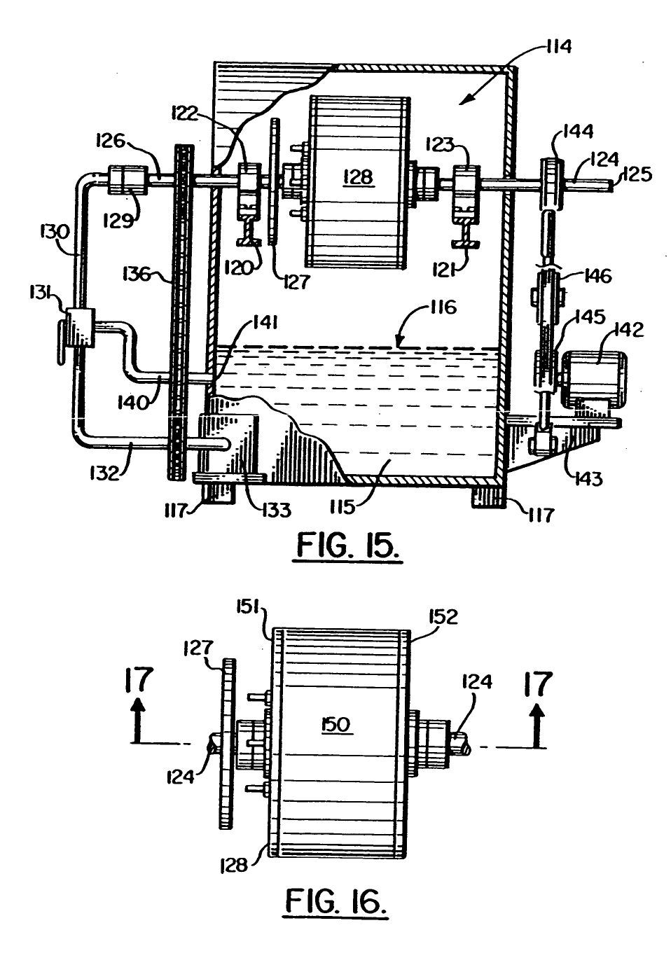

Fluid 115 is contained in the lower portion of reservoir section 112 as shown in FIG. 15, the fluid 115 having a fluid level 116 that is well below chamber 128 and drive shaft 124. The fluid can be any combustible fluid including automatic transmission fluid, hydraulic fluid, vegetable oil, corn oil, or peanut oil, for example. A plurality of feet 117 can be used to anchor housing 111 to a pedestal, mount, concrete base, or like structural support. A pair of sealing mating flanges 118, 119 can be provided respectively on housing sections 112, 113 to form a closure and seal that prevents leakage during use.

A pair of spaced apart transversely extending beams 120, 121 such as the I-beams shown, can be welded to housing reservoir section 112 providing structural support for supporting drive shaft 124 and its bearings 122, 123. The drive shaft 124 is to be driven by a rotating member contained within chamber 128 as will be described more fully hereinafter. For reference purposes, drive shaft 124 has a pair of end portions including starter end portion 125 (right end portion) and fluid inlet end portion 126 (left end portion). Drive shaft 124 carries chamber 128 and flinger plate 127.

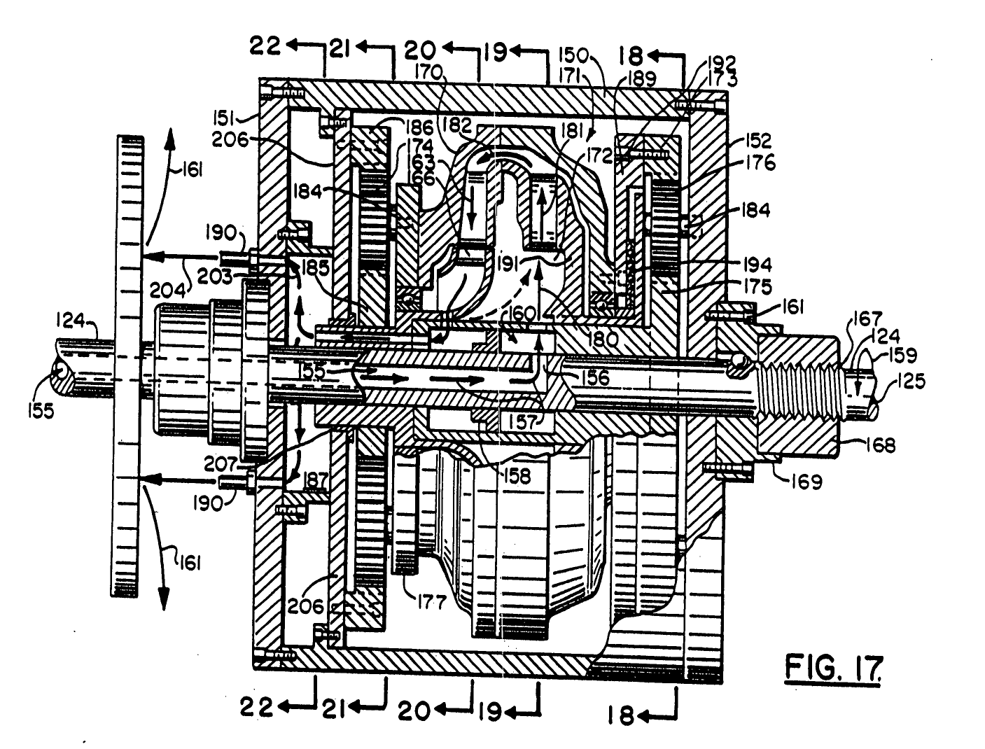

In FIGS. 15-16, the chamber 128 including its cylindrically-shaped wall portion 150 and its circular end walls 151, 152 is mounted integrally to and rotates with shaft 124. Similarly, flinger plate 127 is connected integrally to and rotates with shaft 124. The flinger plate 127 is used to aerate the liquid 115 after it has been transmitted to interior 171 of chamber 128 and exits therefrom through a plurality of jets 190 (see FIGS. 15, 16, 17). The fluid 115 exits via jets 190 and strikes the flinger plate 127 which is rotating with shaft 124 during use. Plate 127 throws the fluid 115 radially away from plate 127 due to the centrifugal force of plate 127 as it rotates with shaft 124.

The circulation of fluid 115 through the apparatus 110 begins at reservoir section 112 wherein a volume of liquid 115 is contained below fluid surface 116 as shown. The complete travel of fluid 115 through the apparatus 110 is completed when fluid exits chamber 128 and strikes flinger plate 127, fluid 115 being thrown off flinger plate 127 as shown by arrows 161 in FIG. 17 to strike housing 111 and then drain to reservoir section 112 of housing 111. This exiting of fluid 115 from chamber 128 so that it strikes flinger plate 127 creates very small bubbles in fluid 115 that will be the subject of combustion when that aerated fluid 115 again enters chamber 128 via shaft 124 bore 155 as will be described more fully herein.

In FIGS. 13-15, fluid 115 from reservoir section 112 is first pumped with pump 133 to flow outlet line 132. This pumping is accomplished initially with a starter motor 142 that rotates shaft 124. The rotating shaft 124 then rotates pump 133 using power take off 136.

Fluid is transferred from reservoir section 112 via outlet port 135 to suction line 134. Fluid flows from suction line 134 to pump 133 and then to flow outlet line 132. The fluid 115 then flows through fluid control valve 131 to flow inlet line 130. A bypass flow line 140 enables a user to divert flow at control valve 131 so that only a desired volume of fluid enters flow inlet line 130 and hollow bore 155 of shaft 124 at swivel or rotary fluid coupling 129. Once fluid 115 is transmitted to bore 155, it flows into the interior 171 of chamber 128 for use as a source of combustion.

Shaft 124 is connected to flow inlet line 130 with rotary fluid coupling 129. Power take off 136 can be in the form of a pair of sprockets 137, 138 connected to pump 133 and drive shaft 124 respectively as shown in FIG. 14. A chain drive 139 can be used to connect the two sprockets 137, 138. Rotation of the drive shaft 124 thus effects a rotation of the pump 133 so that fluid will be pumped from reservoir section 112 of housing 111 via lines 130, 132 to bore 155 of shaft 124 once starter motor 142 is activated. If fluid 115 is to be bypassed using bypass 140, it is simply returned to reservoir section 112 via bypass line 140 and flow port 141. In this manner, the quantity of fluid 115 flowing to interior 171 can be controlled.

The configuration and inner workings of chamber 128 are shown more particularly in FIGS. 15-17. Shaft 124 supports chamber 128. The chamber 128 end wall plates 151, 152 and canister wall 150 are rigidly fastened to shaft 124 and rotate therewith. In FIG. 17, the starter end 125 of shaft 124 has an external threads 167 that accepts lock nut 168. Lock ring 169 bolts to end plate 152 at bolted connections 161. Key 165 locks lock ring 169 and thus end plate 152 to shaft 124. Such a lock ring 169 and lock nut 168 arrangement is also used to affix end plate 151 to the fluid inlet end portion 126 of shaft 124.

Starter motor 142 can be an electric or combustion engine for example. The motor 142 is mounted upon motor mount 143. Shaft 124 provides a sheave 144. Motor drive 142 has a sheave 145. A sheave 146 is provided on clutch 153. The sheaves 144, 145, 146 are interconnected with drive belt 149. Clutch 153 also includes a sheave support 147 and a lever 148 that is pivotally attached to mount 143 and movable as shown by arrow 154 in FIG. 13.

When motor 142 is started and clutch 153 engaged, shaft 124 rotates sprocket 138 and (via chain 139) sprocket 137. The sprocket 137 activates and powers pump 133 to pump fluid 115 from outlet line 134 to line 132 and through line 130 to swivel (e.g. a deublin swivel) fluid coupling 129 mounted on shaft 124. Fluid 115 enters bore or fluid flow channel 155 to port 156 and then to an accumulation or pre-ignition chamber 172. Chamber 172 is preferably always filled with fluid 115.

In order to initiate operation, fluid is pumped using pump 133 and motor 142 from reservoir 115 into bore 155 of shaft 124 and then into transverse port 156 as shown by arrows 157. Fluid discharged from port 156 enters annular chamber 160. Fluid then enters chamber 171 via port 188.

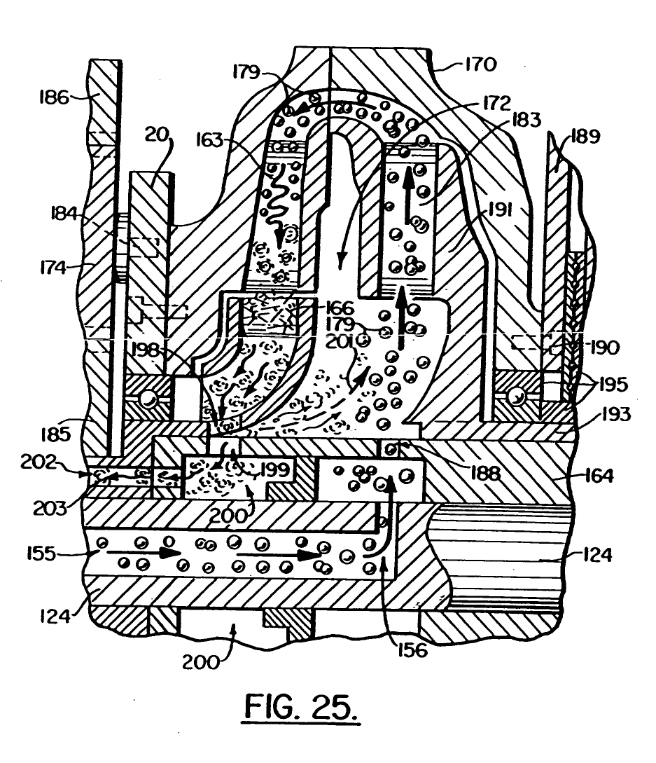

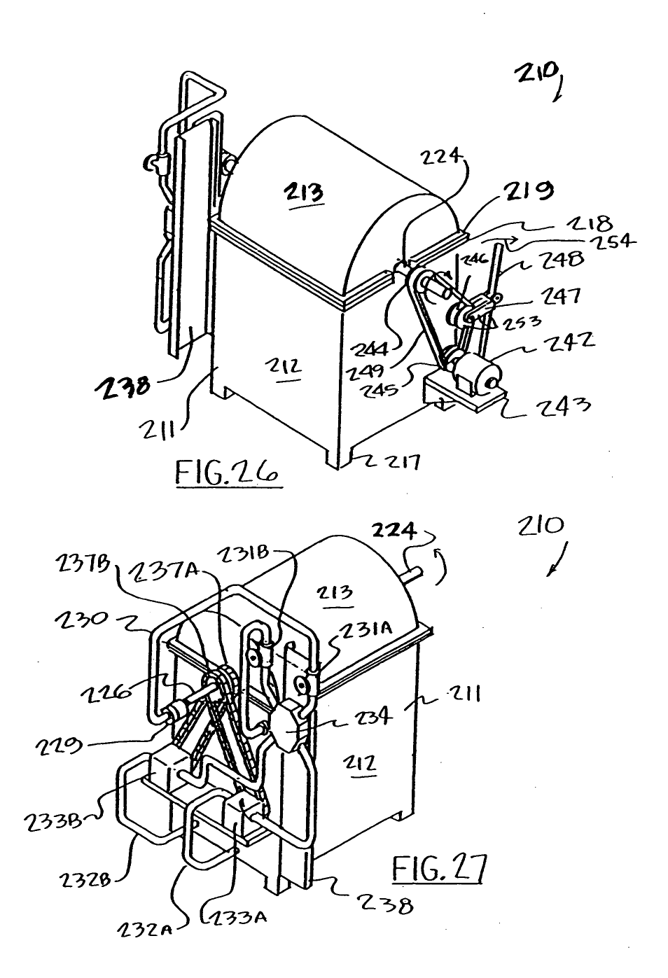

Fluid at arrows 180, 181 strikes compression-impulse drive blades 183 and the fluid rotates with them counterclockwise in relation to starter end 125 of drive shaft 124. Continued fluid flow in the direction of arrow 181, 182 causes fluid 115 to hit combustion channel blades 163 and then torque blades 166. As shown in FIG. 25 fluid 115 carries a large number of small bubbles 179 to blades 183, 163, 166. The compression-impulse drive blades 183 are so angled (i.e. blade pitch), that they act as a pump to pitch up fluid in chamber 172 and drive it into combustion channel blades 163 that are a part of and rotate with combustion channel blades housing 170 (see arrows 180, 181, 182 in FIG. 17).

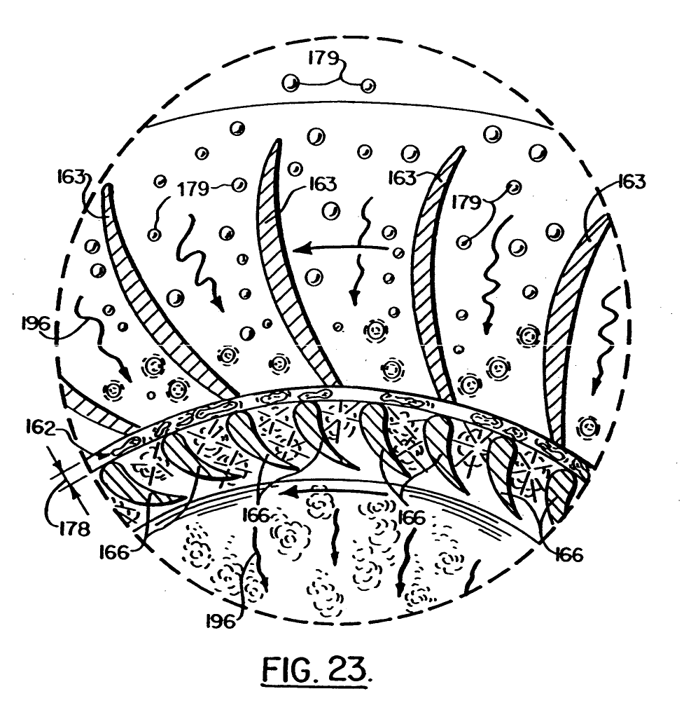

In order to start the engine 110, the user cranks the starter motor 142 until drive shaft 124 rotates to a desired r.p.m. On an actual prototype apparatus 110, the starter motor 142 is cranked until the drive shaft 124 reaches about 1500-1600 r.p.m. At that time, the small air bubbles 179 (containing oxygen and vapor from the fluid 115) begin to burn at the combustion site, designated as 162 in FIGS. 17 and 23 so that the shaft 124 can be driven.

When the matter contained in these bubbles 179 begins to burn, the bubbles 179 expand. In FIGS. 17, 23 and 25, blades or vanes 163, 166 on two rotary parts capture this expansion. The blades or vanes 163, 166 are so positioned and so shaped that two rotary parts rotate at different rotational speeds to compress and ignite the bubbles as one vane 163 closely engages another vane. These two rotary parts are the drive sleeve 164 carrying blades 166 and the combustion channels blade housing 170 carrying blades 163. These rotary parts 164 and 170 are part of the mechanism contained within chamber 28. The blades 163 and housing 170 are connected to a set of planet gears 174 (i.e. left planet gears) and a ring gear 173 (i.e. right ring gear).

The concept of the apparatus 110 of the present invention is to provide an internal energy source (i.e. combustion at site 162 in FIGS. 23-25) in order to put torque on the main drive shaft 124 so that the engine apparatus 110 continues to run from the generated energy of internal combustion. Because of the gearing provided by the assembly of ring gears 173, 186 and planet gears 174, 176 and sun gears 175, 185 the blades 166 rotate faster than blades 163. The close spacing between blades 163, 166 (about 0.030 inches) compresses bubbles 179 at combustion site 162 as each bubble 179 is pinched and compressed in between passing blades 163, 166. Ignition is thus a function of compression of each bubble 179, somewhat analogous to the compressive ignition of a diesel engine.

The right ring gear 173 and right sun gear 175 on the output side (right side) rotate at a faster speed than the output (right side) planet gear 176. The right planet gears are connected to right end wall 152. The wall 152 is attached rigidly to shaft 124.

On the left side, planet gear 174 is rotatably mounted to mounting plate 177 with shaft 184. Plate 177 is rigidly mounted to (e.g. bolted) and rotates with combustion channel blades housing 170 (see FIG. 25). Note that the housing 170 thus carries both the left planet gears 184 using plate 177 and the right (output) ring gear 173 using plate 189. When the left planet gear 184 is driven, the right ring gear 173 is simultaneously driven.

When the left sun gear 185 is driven, the right sun gear 175 is also driven, because the sun gears 175, 185 are connected to and rotate with the drive sleeve 164 that rotates independently of main drive shaft 124. The left ring gear 186 runs at same speed of shaft 124 because it is bolted to thrust wall 206 and thus to chamber 128 at canister wall 150. Bushing 207 is positioned in between thrust wall 206 and drive sleeve 164.

Plant gear (right) 176 and compression-impulse drive blades 183 run at the same rotational speed as drive shaft 124. If the shaft 124 is rotating at an index speed of 1 r.p.m., the left ring gear 186 and right planet gear 170 also rotate at 1 r.p.m. If the ring gear 186 is rotating at 1 r.p.m., the left planet gear 174 will rotate about the shaft at 33% slower rotational speed i.e. 0.66 r.p.m. The planet gear 174 will rotate several times about its own rotational axis as it rotates 0.66 r.p.m. relative to the rotational axis of the shaft. Stated differently, the planet gear mounting plate 177 carrying left planet gears 174 will rotate 0.66 r.p.m. for each 1.0 r.p.m. of shaft 124.

The result of this gearing is that sun gears 175, 185 connected together with drive sleeve 164 will rotate at about 1.5 r.p.m. for each 1.0 r.p.m. of shaft 124 when planet mounting plate 177 is caused by fluid flow to rotate at about the same speed as shaft 124.

Fluid 115 carries small bubbles 179 that will burn at combustion site 162. The interface at combustion site 162 is a very small dimension of about 0.030 inches of spacing between blades 163 and 166, that designated spacing indicated by arrow 178 in FIG. 23.

Once the starter motor reaches about 1600 r.p.m., a stream of fluid 115 containing bubbles 179 which have been impulsed by blades 183 is introduced at interface 162 (combustion site) to generate combustion. The combustion produces an expansion that rotates blades 166 (and everything connected to blades 166) counterclockwise (see arrow 159 in FIG. 17) when looking at the starter end 125 of drive shaft 124. These additional parts that rotate with blades 166 include drive sleeve 164 and sun gears 175, 185.

Combustion channel blades housing 170 is a rotary member that is fastened at bolted connection 205 to plate 189 (see FIGS. 17 and 25). Plate 189 is bolted to ring gear 173 at bolted connection 192 as shown in FIG. 17. The assembly of combustion channel blades housing 170, the combustion channel blades 163, plate 189, and ring gear 173 rotate as a unit. The compression-impulse drive blades 183 are mounted to and rotate with rotary member 191 that is mounted for rotation upon cylindrical sleeve 193 that is also connected for rotation to right planet gear mounting plate 194. Thrust bearing assembly 195 forms an interface in between the two afore described rotating assemblies. One such assembly includes rotating member 191, sleeve 193, and planetary gear mounting plate 194. The other rotating assembly includes combustion channel blades housing 170, plate 189, and ring gear 173. Each of the planet gears 174, 176 provides a planet gear shaft 184 that attaches it to an adjacent mounting plate 177 or 194.

As fluid 115 reaches the combustion site 162 (see FIGS. 23 and 25), the fluid 115 continues movement in the direction of arrows 196 from blades 163 to combustion site 162. Fluid 115 then flows through and below blades 166 in FIG. 23. After combustion occurs, the fluid 115 enters annular chamber 197 and port 198. Flow divider 158 separates chambers 160, 200. Some of the fluid flows through port 199 into annular chamber 200 as shown in FIG. 25. Other flow, as indicated by arrow 201, returns to chamber 172. One or more longitudinally extending channels 202 are provided in drive sleeve 164 for channeling fluid from annular chamber 200 into reservoir 187 as shown in FIGS. 17 and 25. This flow of fluid from torque blades 166 to jets 190 is shown by arrows 203 in FIG. 17. Fluid exiting reservoir 187 is dispensed by jets 190 against flinger plate 127 as indicated by arrows 204 in FIG. 17.

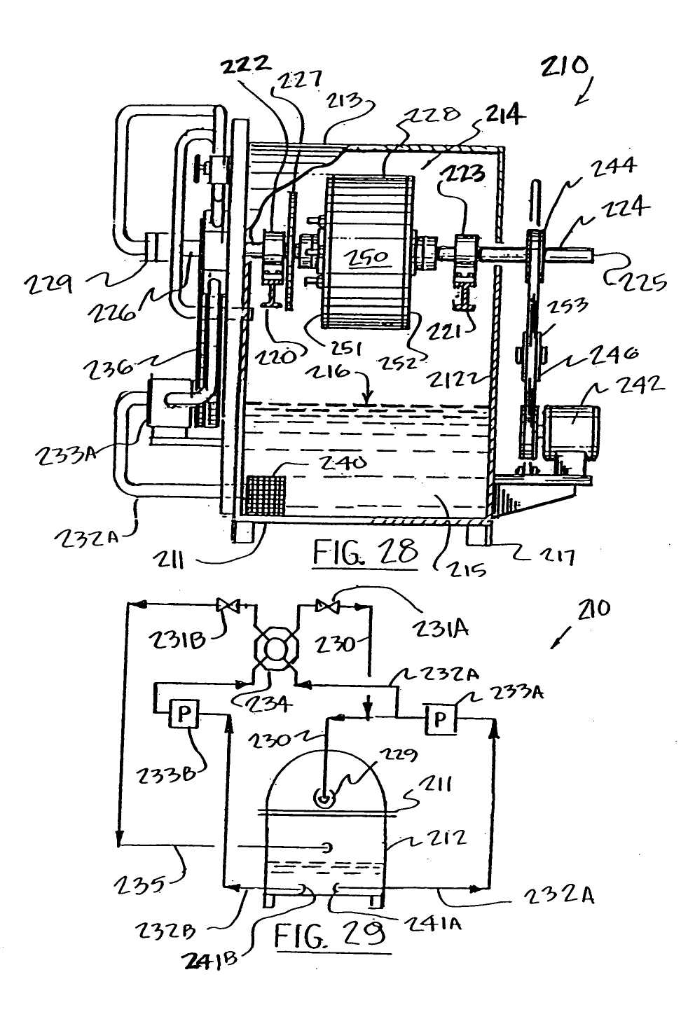

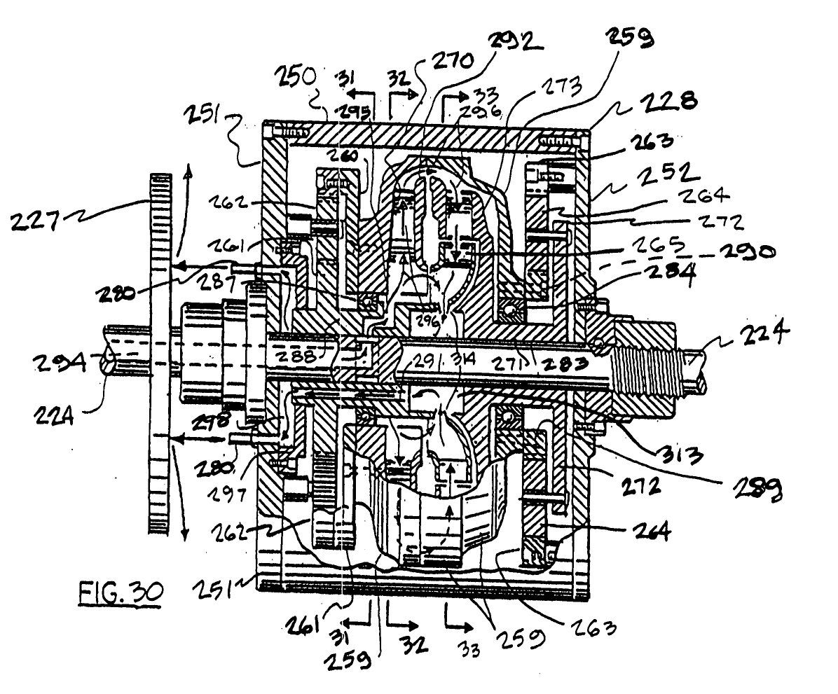

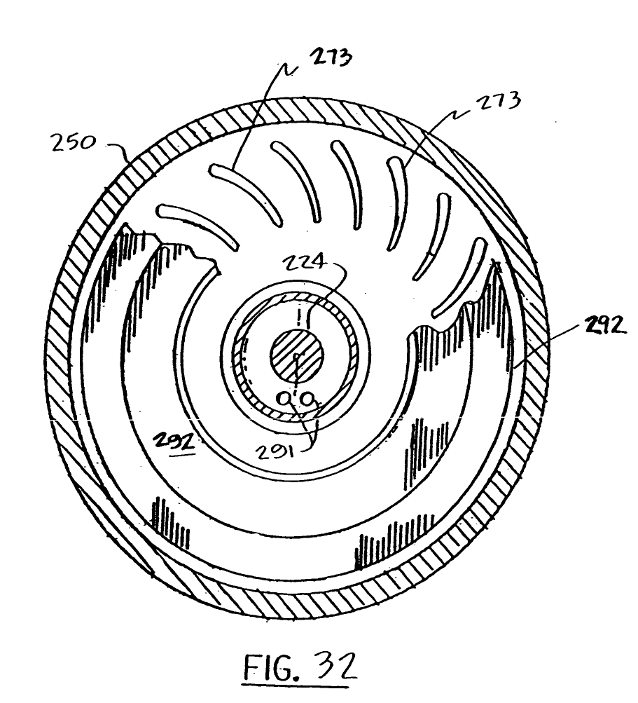

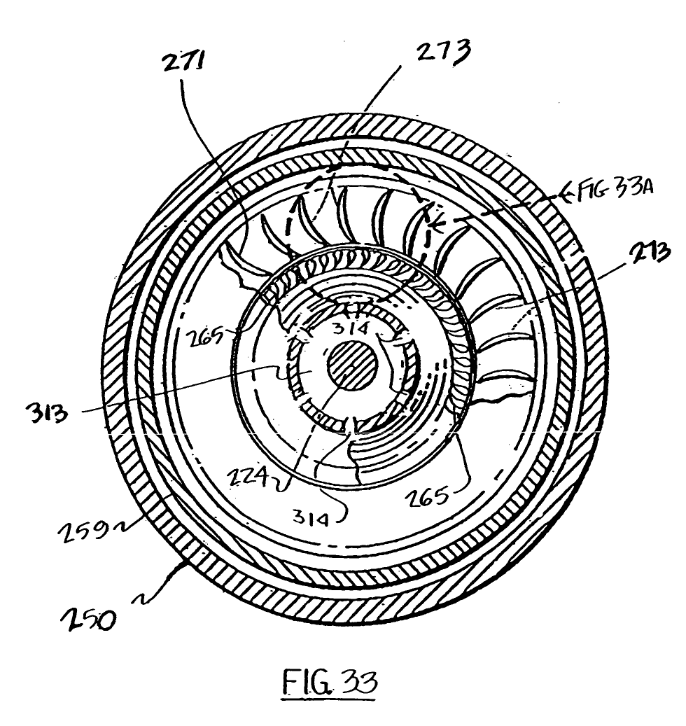

FIGS. 26-34 show a third embodiment of the apparatus of the present invention designated generally by the numeral 210. Combustion engine 210 includes a housing 211 having a reservoir section 212 and a cover 213 that is removably attached to the reservoir section 212. The interior 214 of housing 211 is partially filled with fluid 215, the fluid level being indicated by arrow 216. Housing 211 can be provided with a plurality of feet 217.

In order to perfect a fluid seal between reservoir section 212 and cover 213, a pair of peripheral mating flanges 218, 219 are provided. The flange 218 is on the reservoir section 212. The flange 219 is on the cover section 213.

In FIG. 28, a pair of beams 220, 221 support bearings 222, 233 respectively. Bearings 222, 223 support drive shaft 224. Drive shaft 224 has a starter end portion 225 and a fluid inlet end portion 226. In this application, directions of rotations of various parts will be referred to as either clockwise rotation or counterclockwise rotation. These rotations are always in reference to a viewer standing at the starter end portion 225 of shaft 224 and looking at the machine from the starter end portion 225.

Flinger plate 227 is attached to shaft 224 and rotates therewith. The flinger plate 227 receives fluid that exits cylindrical cannister 250 via nozzles 280. As the fluid exits the chamber 228, it strikes flinger plate 227 and is hurled against the walls of housing 11 because of centrifugal force. Fluid is added to housing 211 at rotary fluid coupling 229 as shown in FIGS. 28 and 29. In FIG. 29, a flow chart of the fluid flow is schematically shown. The fluid 215 is first screened and/or filtered at screen filter 240 and then enters one of the flow outlet pipes 232A or 232B. Hydraulic pumps 233A, 233B pump fluid to flow divider 234. Valves 231A, 231B control the amount of fluid that enters flow lines 230 or 235. The flow lines 232B, 235 define a recirculation flow line that simply routes fluids back to the reservoir section 212. The valve 231A determines the amount of fluid that is routed via flow line 230 to rotary coupling 229 and then to chamber 228.

Hydraulic pumps 233A, 233B are preferably hydraulically driven using power takeoff 236. Power takeoff 236 includes sprockets 237A, 237B and chain drive 239. Vertical support 238 carries flow divider 234 and valves 231A, 231B. Flow ports 241A, 241B transmit fluid to and from housing 211. Port 241A communicates with flow line 232A. Port 241B communicates with flow line 232B.

In FIGS. 26 and 28, starter motor 242 is shown contained upon motor mount 243. A plurality of sheaves 244, 245, 246 are connected by belt 249 as shown. Lever 248 is provided for tightening the belt 249. Sheave support 247 interconnects lever 248 with sheave 246. A user pulls upon the lever 248 in the direction of arrow 254 in order to tighten the belt 249 and impart energy from starter motor 242 to shaft 224, rotating the shaft until combustion occurs within chamber 228.

Chamber 228 includes an outer enclosure defined by cylindrical cannister wall 250 and circular end walls 251, 252. The chamber 228 is connected to shaft 224 and rotates therewith when the clutch 253 comprised of starter motor 242, sheaves 244-246 and belt 249 is engaged. When the shaft 224 is rotated, the power takeoff 236 engages the pumps 233A, 233B to begin pumping fluid 215. The fluid enters shaft flow channel 255 and transverse passageway 256, fluid flowing in the direction of arrow 257. In FIG. 30, the connection between chamber 228 and shaft 224 is shown as including an externally threaded portion 266 of shaft 224 that receives lock nut 267 and lock ring 268. A bolted connection 269 fastens lock ring 268 to end plate 252. A similar connection is formed between end plate 251 and shaft 224 next to flinger plate 227. Chamber 228 and shaft 224 rotate clockwise (viewed from starter motor 242) as one fixed assembly. The shaft 242 is set in bearings 222, 223 (FIG. 28).

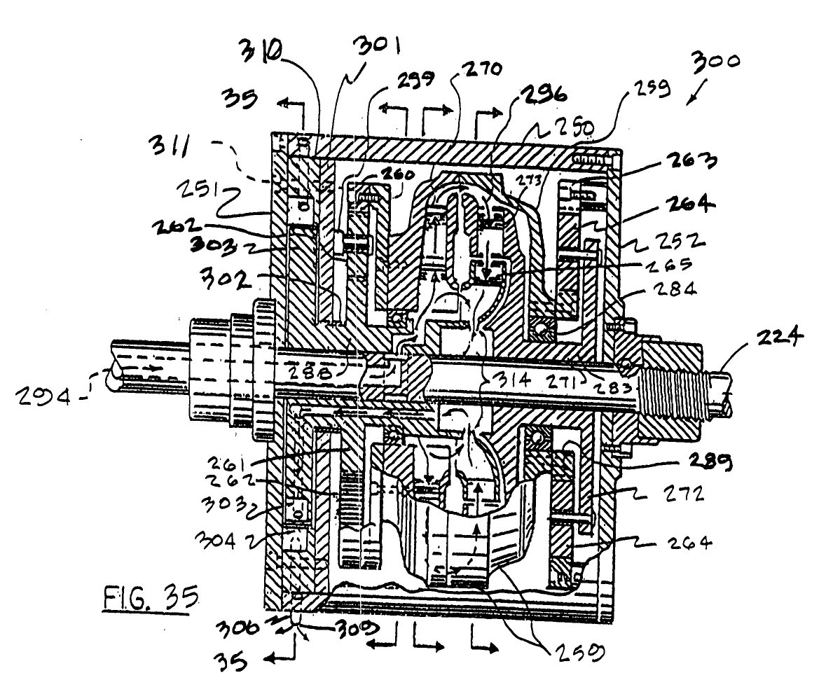

In FIG. 34, an exploded view of the chamber 228 is shown with the cylindrical cannister wall 250 removed for clarity. FIG. 30 shows the internal parts of chamber 228.

In the exploded view of FIG. 34, and in the sectional view of FIG. 30, the left end plate 251 and right end plate 252 are shown attached to shaft 224. Left planet gears 262 are rotatably mounted to left end plate 251 at shafts 281 using fasteners 282. Right ring gear 263 is fastened (eg. bolted) to right end plate 252.

The left ring gear 260 drives the right planet gears 264. The left sun gear 261 rotates counter clockwise as shown in FIG. 34. The left end plate 251 rotates clockwise as shown in FIG. 34 with shaft 224. The left sun gear 261 rotates counter clockwise and is connected to the reaction blades 265. The left ring gear 260 rotates faster than shaft 224, and is connected to the pump blades 270. The pump blades 270 are connected to left ring gear 260 and rotate faster than shaft 224.

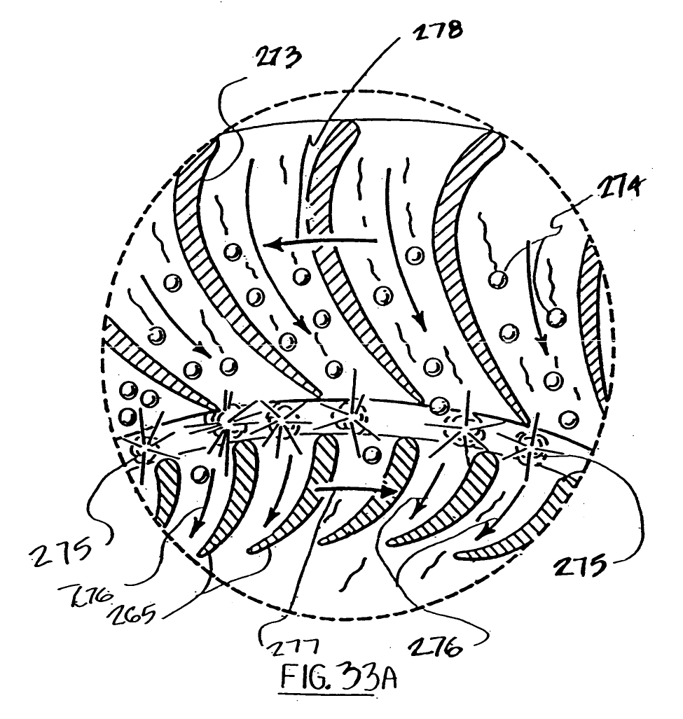

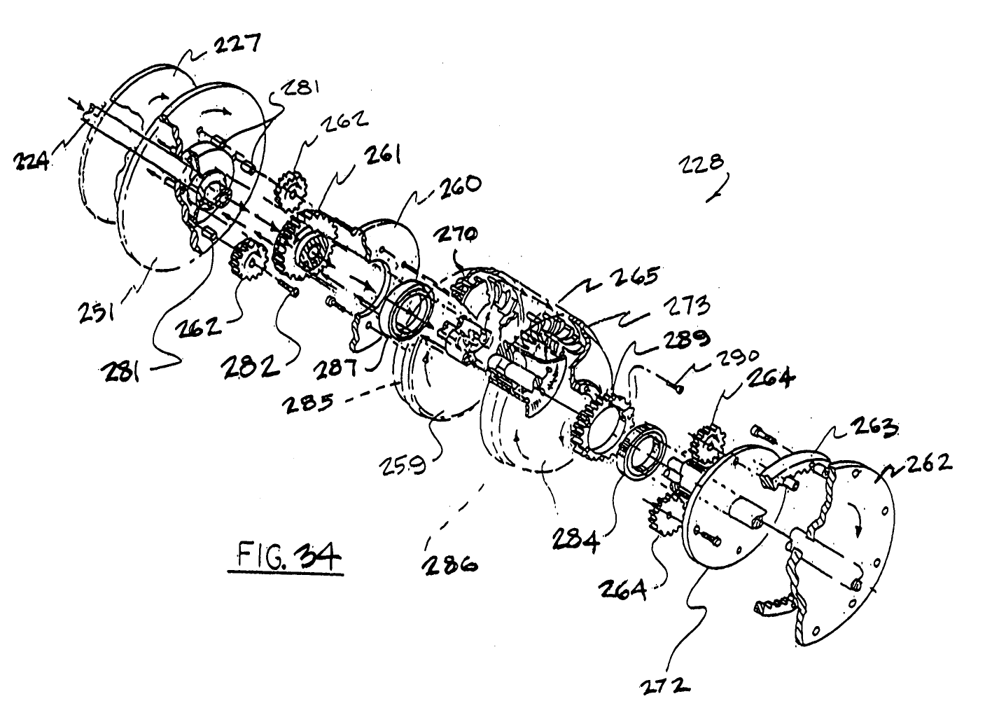

Reaction blades 265 are connected to left sun gear 261 with sleeve 288 and rotate counter clockwise to shaft 224. Pump blades wall 292 is mounted to pump blades 270 (see FIG. 30). The wall 292 acts as a baffle for fluid flow so that fluid traveling from shaft bore 294 through port 293 travels to pump blades 270 and then follows arrows 296 to the periphery of pump blades 270, around the periphery of wall 292 to the periphery of turbine blades 273, in between turbine blades 273 (see FIG. 33A) to reaction blades 275. Sleeve 228 has annular space 313 that collects return fluid exiting reaction blades 265 and transmits such effluent fluid to nozzles 280 via reservoir 298.

Left sun gear 261 can be integrally connected to reaction blades 265 at sleeve 288 as shown in the sectional view of FIG. 30. Bearing 287 forms an interface between sleeve 288 and clam shell housing 259. Turbine 271 is a rotating structure that includes turbine blades 273 and sleeve 283. Bearing 284 forms a rotary interface between sleeve 283 and clamshell housing 259. Clamshell 259 can be comprised of left clamshell half 285 and right clamshell half 286. The halves 285 and 286 are connected together (eg. welded) at their respective peripheries. Right sun gear 289 is fastened (eg. bolted) to right clamshell half 286 using fasteners (eg. bolts) 290.

When filled with fluid, the mere rotation of the chamber 228 will cause the pump blades 270 to centrifugally drive the turbine 271, which is connected to the right planet gears via plate 272. The right planet gears 264 will in turn drive the right ring gear 263 that is mounted on the right end plate 252 which is connected to the shaft 224. The aforementioned rotations result when the reaction blades 265 rotate counter clockwise.

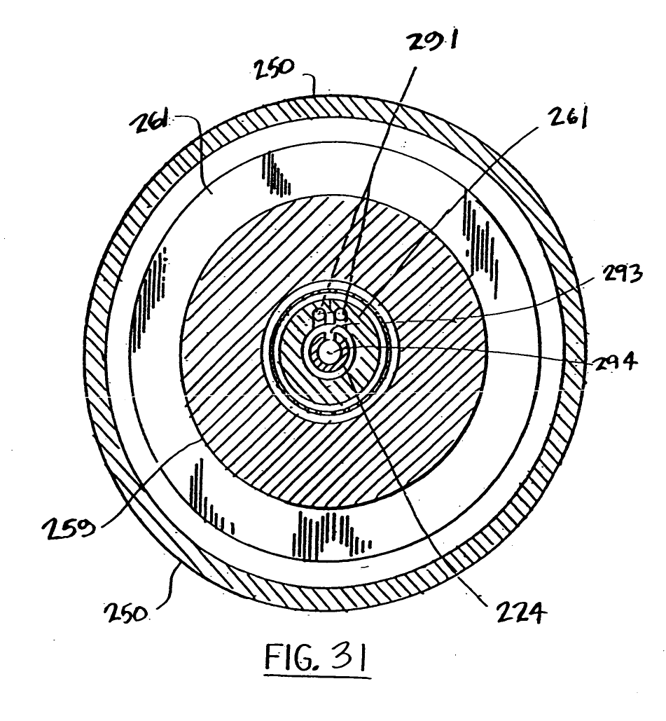

In FIGS. 30 and 31-34, fluid enters bore 294 of shaft 224 and flows to lateral flow port 293 (see FIGS. 30-31). Flow then passes from port 293 via channel 295 (see arrows 296) in sleeve 288 to pump blades 270 and in between clamshell 259 left half 285 and plate 292 that is fastened to blades 270.

Following arrows 296 in FIG. 30, fluid travels to pump the periphery of blades 270, then to the periphery of turbine blades 273 and then to reaction blades 265. As shown in FIG. 34, turbine blades 273 and reaction blades 265 travel in opposite rotational directions so that micro-bubbles 274 traveling with the fluid are combusted at the interface, such combustion designated by the reference numerals 275 in FIG. 34.

By causing the micro bubbles 274 to combust at 275 on the leading edge of the reaction blades 265 (see FIG. 34), the fluid will accelerate down the pitch of the reaction blades 265 toward the shaft 224 turning the reaction blades 265 counter clockwise as shown by arrow 277 in FIG. 34. The fluid then exits reaction blades 265 through ports 314 to annular space 313 to thrust jets 280 going from a high pressure containment to a low pressure zone, striking flinger plate 227. Hence, the chamber 228 is driven by micro-bubble 274 combustion at 275 and thrust.

The micro-combustion chamber heat engine 210 needs no outside mechanical grounding. The turbine blades 273 rotate in the direction of arrow 278 and eventually rotate right end plate 252. The reaction blades 265 rotate in the direction of arrow 277 to rotate pump blades 270. The centrifugal force produced by the rotation of the chamber 228 causes the fluid to flow over the different blades inside the chamber. The fluid moves the blades 273 and 265 and the blades 273, 265 move the connected gears (planet and sun).

By adding a net energy gain through micro-bubble combustion, the apparatus 210 continually energizes the fluid through a continuous stream of bubble 274 burn 275. In addition, since the bubble 274 is the combustion chamber, engine size can be scaled down to micro technology without compromising power output and without producing any noticeable amount of CO or CO₂.

Fluid exiting reaction blades 265 flows through ports 314 to annular space 313 to channel 291 and then to reservoir 298 that is surrounded by reservoir wall 297 and then exits chamber 228 at nozzle jets 280, striking flinger plate 227 to aerate the fluid and produce micro-bubbles. Additional micro-bubbles form in the fluid when it travels from flinger plate 227 and strikes the canister wall 250.

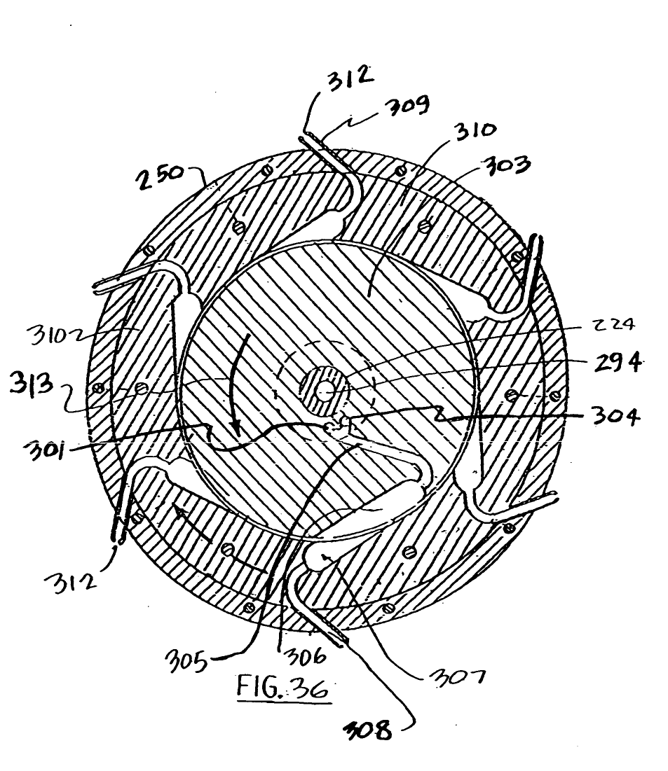

FIGS. 35-36 show a fourth embodiment of the apparatus of the present invention, wherein the chamber 300 replaces the chamber 228 of the third embodiment 210. In FIGS. 35-36, certain parts attached to left end plate 251 are provided that redirect fluid flow exiting chamber 228. Otherwise, the working parts of chamber 228 are the same as those shown in FIG. 30. In FIG. 35, the new parts are those to the left of left sun gear 261 and include generally plate 301, bearing 302, rotating member 303 and peripheral member 310.

Rotating member 303 is preferably integral with sleeve 288. Thus, member 303 replaces reservoir wall 297 of the embodiment of FIG. 30. Jets 280 and reservoir 298 are also eliminated. Planet gears 262 are now (FIG. 35) mounted upon plate 301 at planet gear mounts 299 instead of to end wall 251. End wall 251 and plate 301 are affixed together using bolted connections 308.

Expander plate 303 rotates with sleeve 288 and sun gear 261. Plate 301 is bolted to end plate 251 (eg. with bolted connections 311) and with peripheral member 310 being positioned as shown in FIG. 35 in between end plate 251 and plate 301. Bearing 302 defines an interface between sleeve 288 and plate 301.

During use, fluid flows via ports 304 to channels 302 in expander plate 303 (see FIG. 30). Fluid then enters chamber 306. Because plate 303 rotates in the direction of arrow 313 and member 310 rotates in the direction of arrow 313, fluid entering chamber 306 builds up back pressure until chambers 306 align with chambers 307. Once fluid from chamber 306 mixes with chamber 307, rotational speeds of members 303, 310 increase. Fluid then exits chamber 297 via channels 308, tube 309 and nozzles 312.

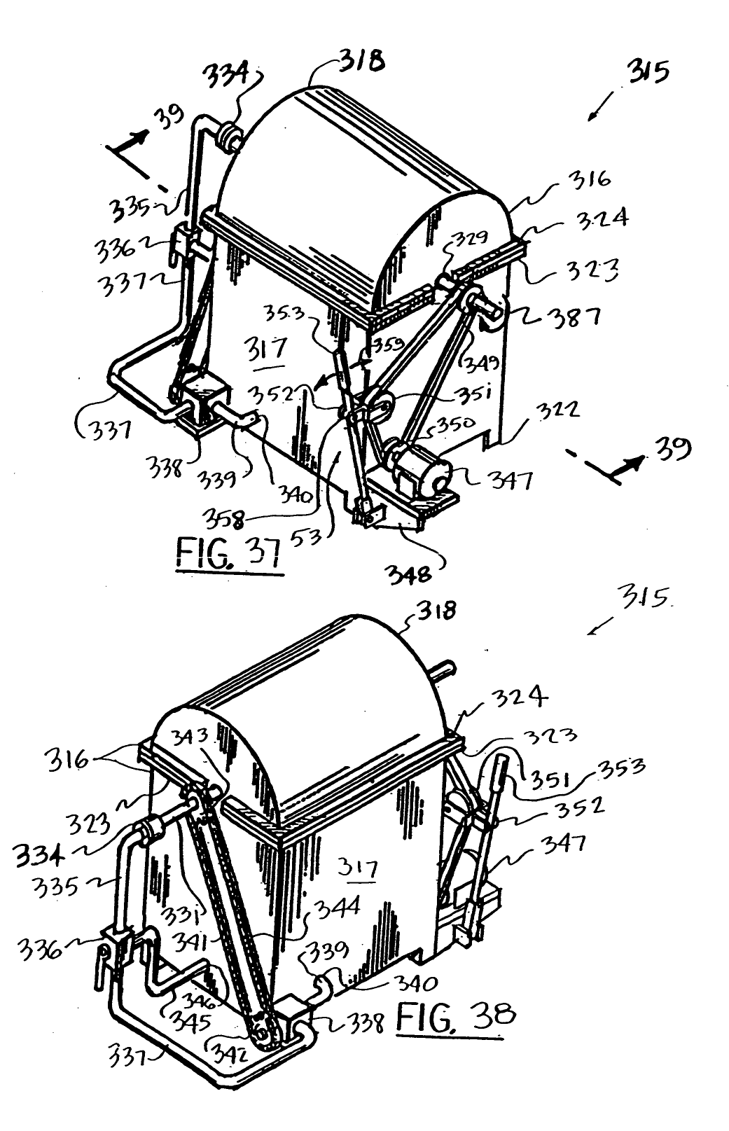

FIGS. 37-47 show generally the fifth embodiment of the apparatus of the present invention, designated generally by the numeral 315 in FIGS. 37, 38, and 39. Combustion engine 315 has an enlarged housing 316 with an interior 319. The housing 316 is comprised of upper and lower sections including a lower reservoir section 317 and an upper cover section 318.

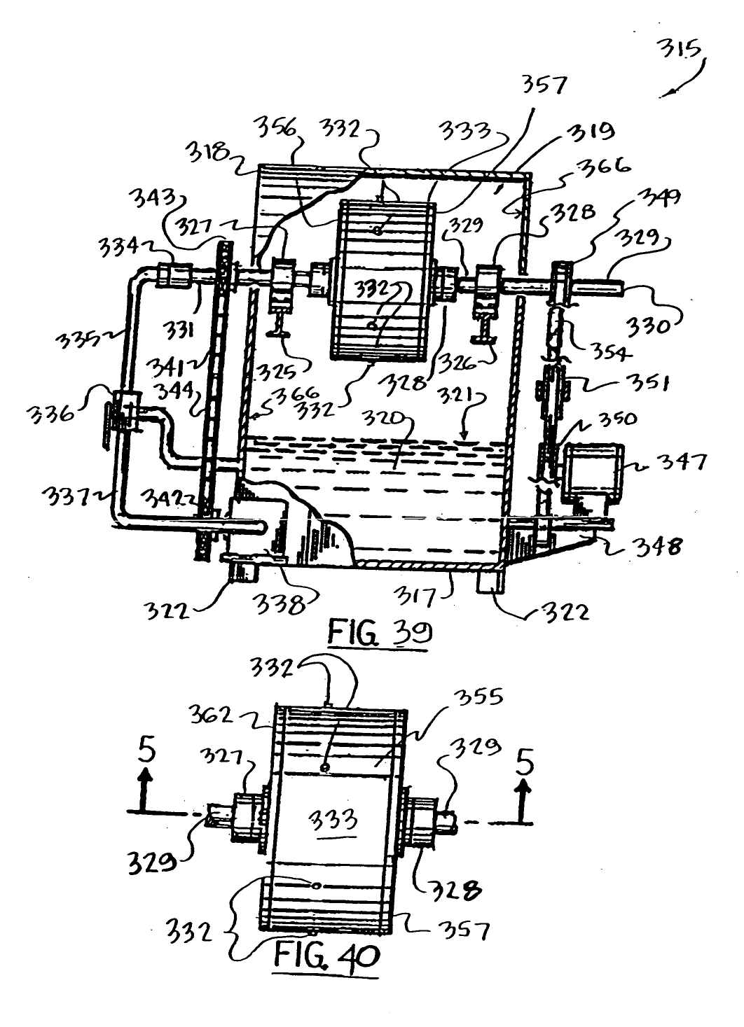

Fluid 320 is contained in the lower portion of reservoir section 317 as shown in FIG. 39, the fluid 320 having a fluid level 321 that is well below chamber 333 and drive shaft 329. The fluid 320 can be most any combustible fluid including automatic transmission fluid, hydraulic fluid, vegetable oil, corn oil, peanut oil, for example.

A plurality of feet 322 can be used to anchor housing 316 to a pedestal, mount, concrete base, or like structural support. A pair of sealing mating flanges 323, 324 can be provided respectively on housing sections 317, 318 to form a closure and seal that prevents leakage during use.

A pair of spaced apart transversely extending beams 325, 326 such as the I-beams shown, can be welded to housing reservoir section 317 providing structural support for supporting drive shaft 329 and its bearings 327, 328. The drive shaft 329 is to be driven by a rotating member contained within chamber 333 as will be described more fully hereinafter. For reference purposes, drive shaft 329 has a pair of end portions including starter end portion 330 and fluid inlet end portion 331.

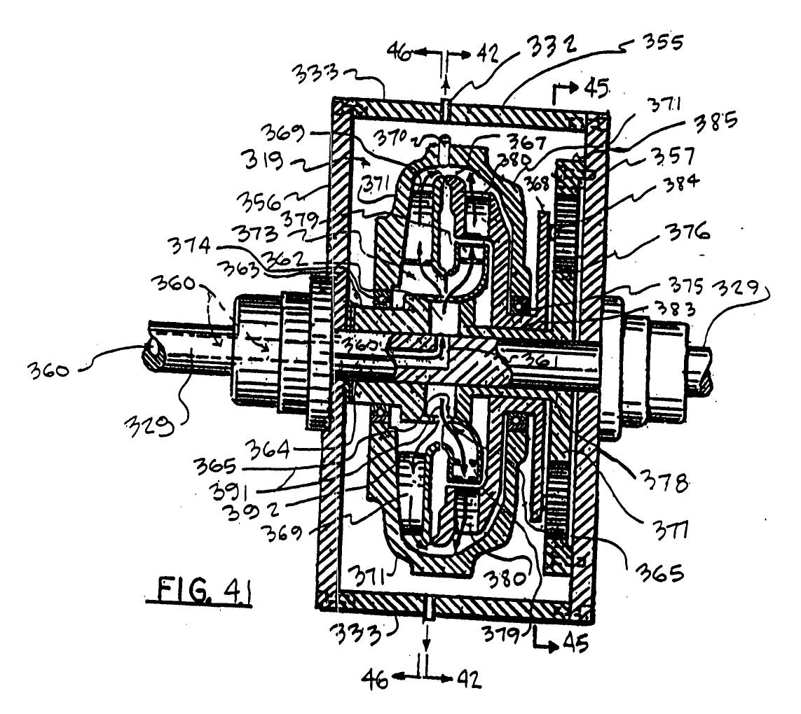

In FIGS. 39-40, the chamber 333 including its cylindrically-shaped wall portion 355 and its circular end wall plates 356, 357 is mounted integrally to and rotates with shaft 329. Cylindrically shaped wall portion 355 has a plurality of fluid outlet jets 332 that enable fluid to exit chamber 333. The fluid 320 that exits chamber 333 via jets 332 strikes the inside surface 366. The fluid 320 is thrown radially away from wall portion 355 due to the centrifugal force of wall portion 355 as it rotates with shaft 329.

The circulation of fluid 320 through the apparatus 315 begins at reservoir section 317 wherein a volume of fluid 320 is contained below fluid level 321 as shown in FIG. 39. The travel of fluid 320 through the apparatus 315 is completed when fluid 320 exits chamber 333 via jets 332 and is thrown against inner surface 366 of housing 316 and then draining to reservoir section 317 of housing 316. This exiting of fluid 320 from chamber 333 so that it strikes housing 316 inner surface 366 creates very small bubbles in fluid 320 that will be the subject of combustion when that aerated fluid 320 again enters chamber 333 via shaft 329 flow channel 360 and radial passageway 361 as will be described more fully herein.

In FIGS. 37-41, fluid 320 from reservoir section 317 is first pumped with positive displacement rotary fluid pump 338 to flow outlet line 337. Pumping of fluid 320 is accomplished initially with a starter motor 347 that rotates shaft 329. The rotating shaft 329 then rotates pump 338 using power take off 341.

Fluid 320 is transferred from reservoir section 317 via outlet port 340 to suction line 339. Fluid 320 flows from suction line 339 to pump 338 and then to flow outlet line 337. The fluid 320 then flows through control valve 336 to flow inlet line 335. A bypass line 345 enables a user to divert flow at control valve 336 so that only a desired volume of fluid 320 enters flow inlet line 335 and hollow bore 360 of shaft 329 at rotary coupling 334. Once fluid 320 is transmitted to bore 360, it flows via radial passageway 361 into the interior 319 of chamber 333 for use as a source of combustion as will be described more fully hereinafter.

Shaft 329 can be connected to flow inlet line 335 with a rotary fluid coupling 334. Power take off 341 can be in the form of a pair of sprockets 342, 343 connected to pump 338 and drive shaft 329 respectively as shown in FIG. 38. A chain drive 344 can be used to connect the two sprockets 342, 343. Rotation of the drive shaft 329 thus effects a rotation of the pump 338 so that fluid 320 will be pumped from reservoir section 317 of housing 316 via lines 335, 337 to channel 360 of shaft 329 once starter motor 347 is activated. If fluid 320 is to be bypassed using bypass 345, it is simply returned to reservoir section 317 via bypass line 345 and port 346.

Starter motor 347 can be an electric motor or internal combustion engine for example. The motor 347 is mounted upon motor mount 348. Shaft 329 provides a sheave 349. Motor drive 347 has a sheave 350. A sheave 351 is provided on clutch 358. The sheaves 349, 350, 351 are interconnected with drive belt 354. Clutch 358 also includes a sheave support 352 and a lever 353 that is pivotally attached to mount 348 and movably as shown by arrow 359 in FIG. 37.

To start the engine 315, the user cranks the starter motor 347 until drive shaft 329 rotates to a desired RPM. On an actual prototype apparatus 315, the starter motor 347 is cranked until the drive shaft 329 reaches about 1000-1600 RPM's. The starter motor 347 thus initiates operation, by activating pump 338 to pump fluid 320 from reservoir 317 into flow channel 360 of shaft 329 and then into transverse passage way 361.

Radial passageway 361 communicates with annular chamber 362 of hub 363. Hub 363 has a central opening 364 that receives shaft 329 so that hub 363 closely fits shaft 329, but spins with respect to, shaft 329. Hub openings 365 are circumferentially spaced, radially extending openings in hub 363 that enable fluid 320 to flow from annular chamber 363 of hub 363 to the annular chamber 373 that is radially positioned away from hub openings 365 and that is sandwiched between clamshell housing 371 and hub 363.

Clamshell housing 371 is rotatably mounted to hub 363 using bearings 374, 375. Compression drive blades 369 are fixedly attached to clamshell housing 371. Sun gear 376 attaches to hub 377. Hub 377 has central opening 378 that is sized and shaped to closely fit shaft 329. Hub 377 also carries reaction blades 379. Hub 368 connects planet gears 381 to combustion channel blades 380. Hub 368 has central opening 382 that is sized and shaped to fit the outer surface 383 of hub 377.

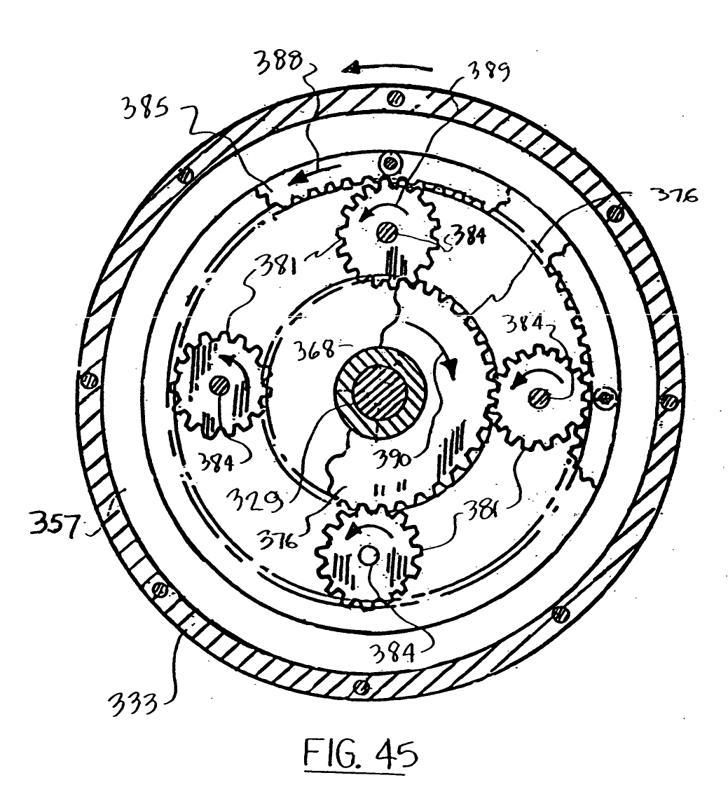

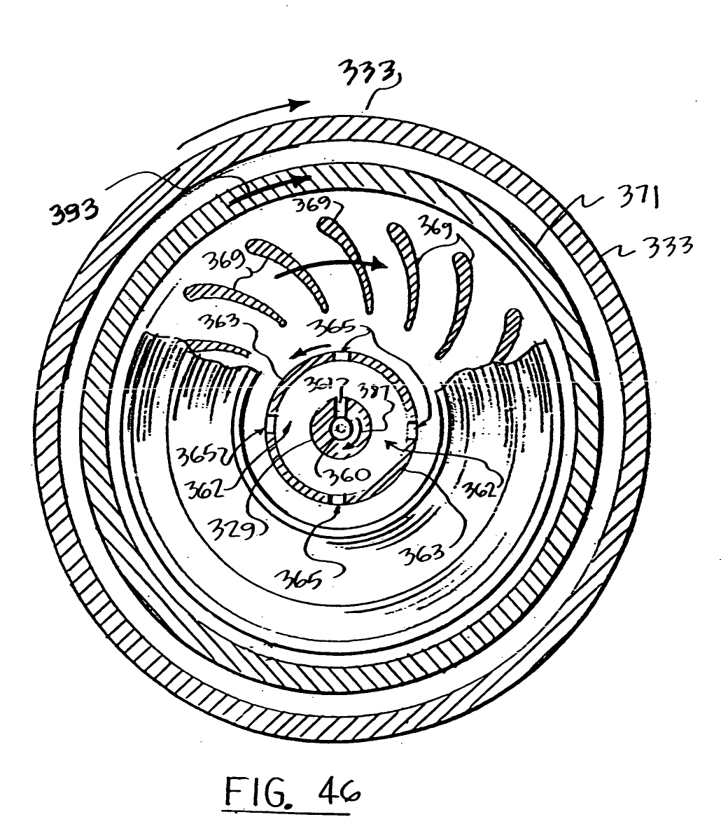

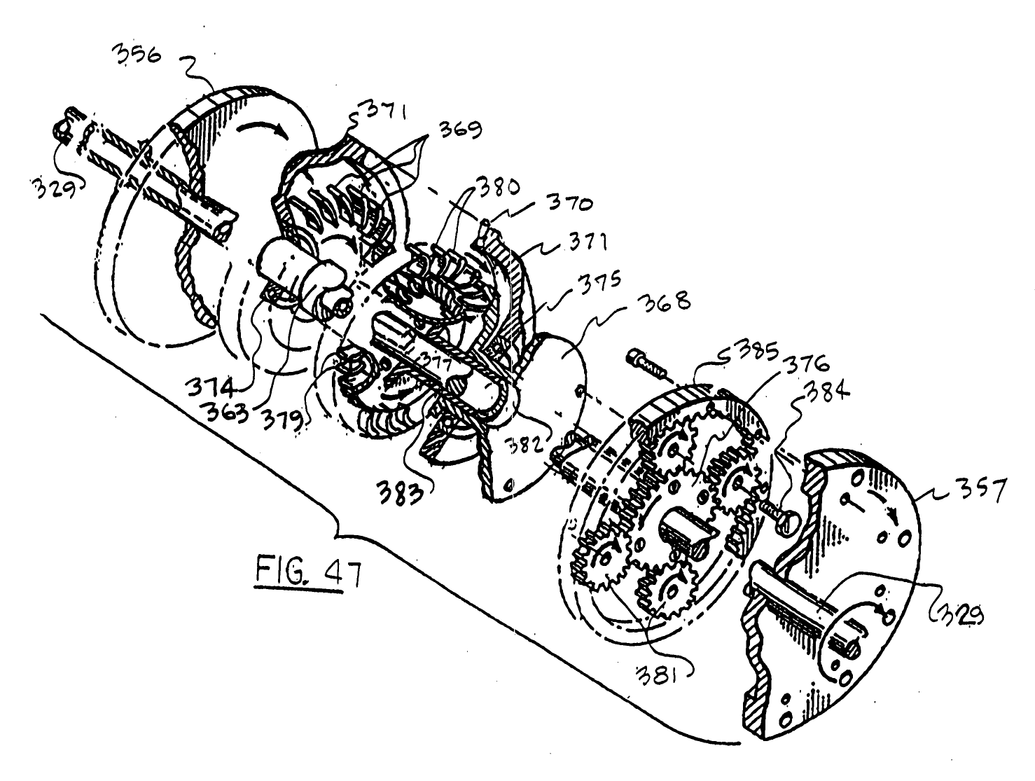

In FIGS. 45 and 47 each planet gear 381 attaches to hub 368 with a planet gear shaft 384. Each planet gear 381 is engaged by sun gear 376 and ring gear 385. Ring gear 385 is attached to and rotates with chamber 333. Ring gear 385 can be attached (e.g. bolted) to plate wall 357.

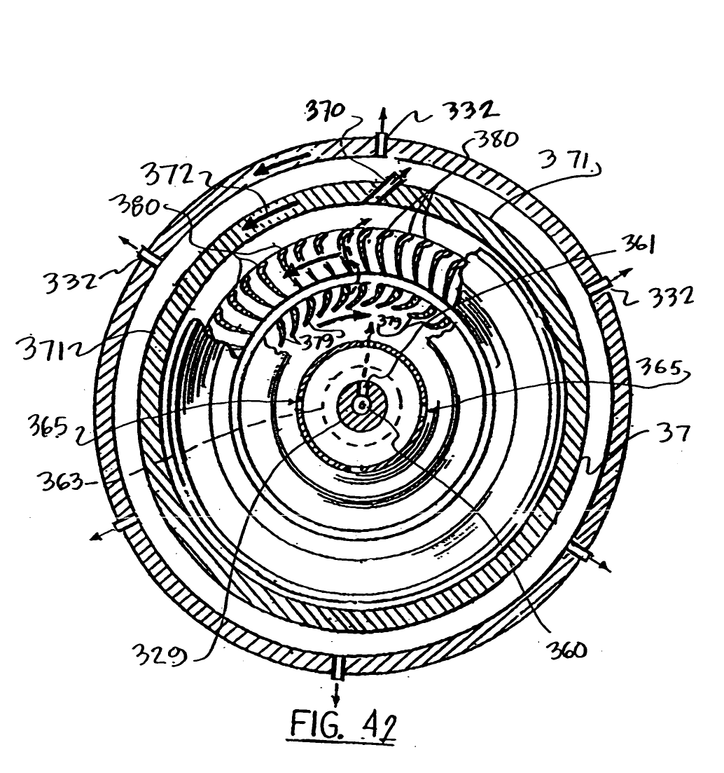

Angled thrust tube 370 is mounted on clamshell housing 371 next to combustion site 367. As shown in FIGS. 41, 42, 43, 44 and 47, the thrust tube 370 is angled so that when combustion occurs in the small bubbles that are carried in fluid 320 at combustion site 367, expanding fluid exits tube 370 as schematically illustrated by arrow 386 in FIG. 44, rotating clamshell housing 371 in the direction of arrow 372 in FIG. 42. Small air bubbles (containing oxygen and vapor from the fluid 320) are conveyed to and begin to burn at combustion site 367 in FIG. 41. When the matter in these bubbles begins to combust, the bubbles expand. In FIG. 41, a thrust tube (or tubes) 370 capture this expansion. The thrust tube 370 is so positioned and shaped that it rotates clamshell housing 371 in the direction of arrow 372.

Using starter motor 347, shaft 329 is initially rotated in a clockwise direction as indicated by arrow 387 in FIG. 37. Rotation of shaft 329 also rotates housing 333 and ring gear 385 in the same clockwise direction as viewed in FIG. 37. In the sectional view of FIG. 45, the rotation of ring gear 385 is indicated by arrow 388. Arrow 389 shows the direction of rotation for each planet gear 381.

Arrow 390 shows the rotation of sun gear 376. When shaft 329 is driven by starter motor 347, sun gear 376 drives the reaction blades 379 to rotate in the same direction as sun gear rotation arrow 390. Combustion channel blades 380 rotate in the same direction as ring gear 385 and in an opposite direction from reaction blades 379 (see FIGS. 42, 43 and 44).

Fluid 320 that flows through bore 360 to radial passageway 361 divides into two flow components, (see arrows 391, 392 in FIG. 41) following the path of least resistance so that some fluid 320 flows to reaction blades 379 and some fluid 320 flows to compression drive blades 369 (see FIGS. 41, 42).

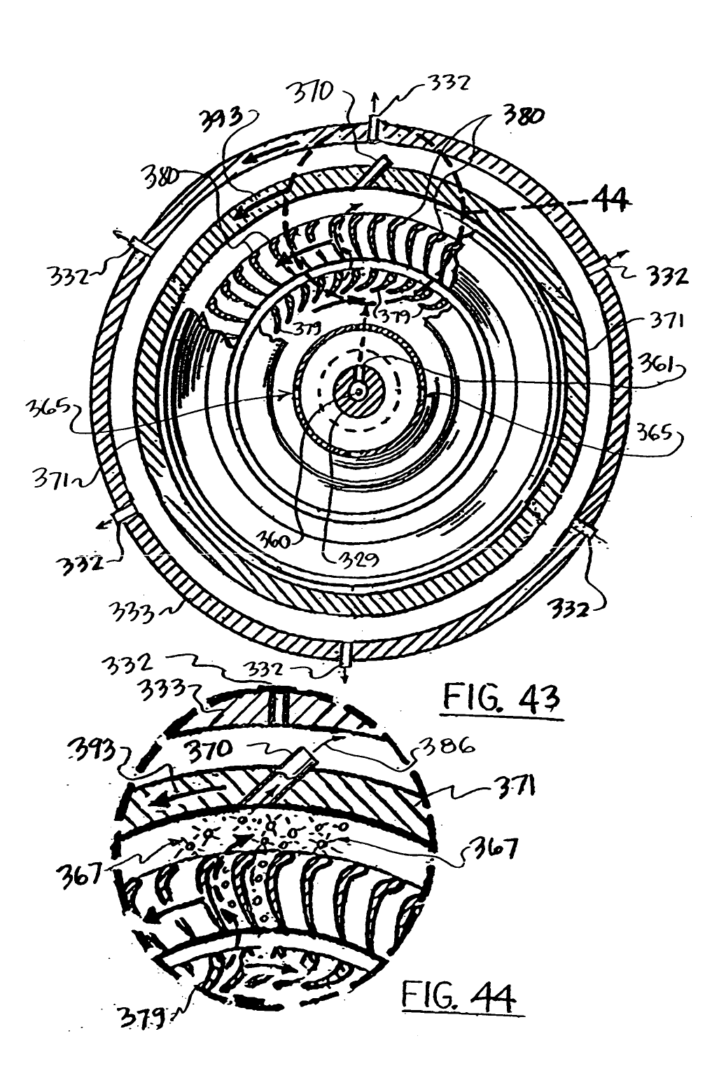

Once the chamber 333 is filled with fluid 320, the fluid 320 becomes pressurized because pump 338 tries to transmit more fluid 320 into chamber 333 than can be discharged from chamber 333, and the pressurized fluid 320 begins to push on the blades 379, 380. The pitch of the blades 379, 380 attempt to channel the fluid 320 as it flows between the blades 379 and then 380 (see FIGS. 43, 44). The sun gear 376 rotates in the direction of arrow 390 as compared to arrow 388 of ring gear 388. As fluid 320 leaves compression drive blades 369, it collides with fluid 320 exiting combustion channel blades 380. These colliding fluid streams carry very tiny bubbles filled with a combination of vapor of the fuel (fluid 320) and oxygen. They are compressed sufficiently to cause combustion inside each bubble. The expanding gas produced by combustion of the tiny bubbles in fluid 320 attempts to exit clamshell housing 371 via angled thrust tube 370, rotating clamshell housing 371 in the same direction as chamber 333 (see arrow 393 in FIG. 46).

As combustion of small bubbles occurs at combustion site 367, motor 347 is no longer needed as the sole drive for shaft 329. Rather, the rotating clamshell housing 371 and its drive blades 369 rotate as the bubble combustion causes expanding gas to exit tube 370.

Because of the gearing of FIG. 45, the combustion channel blades 380 rotate at a slower speed. The faster rotating compression drive blades 369 attempt to pump fluid back across combustion site 367 in the direction of the combustion channel blades 380. However, fluid 320 continues to inflow via channel 360, passageway 361 and annular chamber 362 to blades 379 and 380. The fluid 320 that is pumped by rotating blades 369 on clamshell housing 371 pumps against blades 380 and rotates them in the same direction as arrow 393 (see FIGS. 41, 42, and 46). Blades 380 are connected to planet gears 381. As the planet gears move in the direction of arrow 388, sun gear 376 rotates in the direction of arrow 390. The ring gear 385 is driven by planet gears 381 to rotate and drive shaft 329 that is attached to ring gear 385 via chamber 333 and wall plate 357.

The following table lists the parts numbers and parts descriptions as used herein and in the drawings attached hereto.

PARTS LIST

| Part Number | Description |
|---|---|
| 10 | combustion engine |
| 11 | housing |
| 12 | reservoir section |
| 13 | cover |
| 14 | interior |
| 15 | fluid |
| 16 | fluid level |
| 17 | feet |
| 18 | flange |
| 19 | flange |
| 20 | beam |
| 21 | beam |
| 22 | bearing |
| 23 | bearing |
| 24 | drive shaft |
| 25 | starter end portion |
| 26 | fluid inlet end portion |
| 27 | flinger plate |
| 28 | chamber |
| 29 | rotary fluid coupling |
| 30 | flow inlet line |
| 31 | fluid control valve |
| 32 | flow outlet line |
| 33 | pump |
| 34 | suction line |
| 35 | flow port |
| 36 | power take off |
| 37 | sprocket |
| 38 | sprocket |
| 39 | chain drive |
| 40 | bypass flow line |
| 41 | flow port |
| 42 | starter motor |
| 43 | motor mount |
| 44 | sheave |
| 45 | sheave |
| 46 | sheave |
| 47 | sheave support |
| 48 | lever |
| 49 | belt |
| 50 | cylindrical canister |
| 51 | circular end wall plate |
| 52 | circular end wall plate |
| 53 | clutch |
| 54 | arrow |
| 55 | shaft flow channel |
| 56 | transverse passageway |
| 57 | arrows |
| 58 | bushing |
| 59 | sleeve |
| 60 | impulse drive unit |
| 61 | arrow |
| 62 | combustion site |
| 63 | impulse drive blades |
| 65 | combustion channels |
| 66 | externally threaded portion |
| 67 | lock nut |
| 68 | lock ring |
| 69 | bolted connection |
| 70 | key |
| 71 | interior |
| 72 | bearing |
| 73 | sleeve |
| 74 | flow outlet opening |
| 75 | arrow |
| 76 | blades |
| 77 | compression drive unit |
| 78 | bolted connection |
| 79 | bubbles |
| 80 | arrow |
| 81 | arrow |
| 82 | cavity |
| 83 | combustion channel blades |
| 84 | combustion channel unit |
| | inner housing |
| 85 | planet gear mounting plate |
| 86 | bolted connection |
| 87 | planet gear |
| 88 | sun gear |
| 89 | ring gear |
| 90 | fluid outlet jet |
| 91 | arrow |
| 92 | bolted connection |
| 93 | splined connection |
| 94 | bolted connection |
| 95 | rotary bushing |
| 96 | bearing |
| 100 | gap |
| 101 | flow channel |
| 102 | reservoir |
| 103 | receptacle |
| 104 | bolted connection |
| 105 | connection |
| 106 | arrow |
| 110 | combustion engine |
| 111 | housing |
| 112 | reservoir section |
| 113 | cover |
| 114 | interior |
| 115 | fluid |
| 116 | fluid level |
| 117 | feet |
| 118 | flange |
| 119 | flange |
| 120 | beam |
| 121 | beam |
| 122 | bearing |
| 123 | bearing |
| 124 | drive shaft |
| 125 | starter end portion |
| 126 | fluid inlet end portion |
| 127 | flinger plate |
| 128 | chamber |
| 129 | rotary fluid coupling |
| 130 | flow inlet line |
| 131 | fluid control valve |
| 132 | flow outlet line |
| 133 | pump |
| 134 | suction line |
| 135 | outlet port |
| 136 | power take off |
| 137 | sprocket |
| 138 | sprocket |
| 139 | chain drive |
| 140 | bypass flowline |
| 141 | flow port |
| 142 | starter motor |
| 143 | motor mount |
| 144 | sheave |
| 145 | sheave |
| 146 | sheave |
| 147 | sheave support |
| 148 | lever |
| 149 | drive belt |
| 150 | cylindrical canister wall |
| 151 | circular end wall plate |
| 152 | circular end wall plate |
| 153 | clutch |
| 154 | arrow |
| 155 | shaft flow bore |
| 156 | transverse port |
| 157 | arrow |
| 158 | flow divider |
| 159 | shaft rotation arrow |
| 160 | annular chamber |
| 161 | bolted connection |
| 162 | combustion site |
| 163 | combustion channel blade |
| 164 | drive sleeve |
| 165 | key |
| 166 | torque blade |
| 167 | external threads |
| 168 | lock nut |
| 169 | lock ring |
| 170 | combustion channel blades housing |
| 171 | interior |
| 172 | pre-ignition chamber |
| 173 | right ring gear |
| 174 | left planet gear |
| 175 | right sun gear |
| 176 | right planet gear |
| 177 | planet gear mounting plate |
| 178 | arrow |
| 179 | bubbles |
| 180 | arrow |
| 181 | arrow |
| 182 | arrow |
| 183 | compression-impulse drive blade |
| 184 | planet gear shaft |
| 185 | left sun gear |
| 186 | left ring gear |
| 187 | reservoir |
| 188 | port |
| 189 | plate |
| 190 | jets |
| 191 | rotary member |
| 192 | bolted connection |
| 193 | sleeve |
| 194 | planetary gear mounting plate |
| 195 | thrust bearing assembly |
| 196 | arrows |
| 197 | chamber |
| 198 | port |
| 199 | port |
| 200 | annular chamber |
| 201 | arrow |
| 202 | channels |
| 203 | arrow |
| 204 | arrow |
| 205 | bolted connection |
| 206 | thrust wall |
| 207 | bushing |
| 210 | combustion engine |
| 211 | housing |
| 212 | reservoir section |
| 213 | cover |
| 214 | interior |
| 215 | fluid |
| 216 | fluid level |
| 217 | feet |
| 218 | flange |
| 219 | flange |
| 220 | beam |
| 221 | beam |
| 222 | bearing |
| 223 | bearing |
| 224 | drive shaft |
| 225 | starter end portion |
| 226 | fluid inlet end portion |
| 227 | flinger plate |
| 228 | chamber |
| 229 | rotary fluid coupling |
| 230 | flow inlet line |
| 231A | fluid control valve |
| 231A | fluid control valve |
| 232A | flow outlet pipe |
| 232B | flow outlet pipe |
| 233A | pump |
| 233B | pump |
| 234 | flow divider |
| 235 | recirculation line |
| 236 | power takeoff |
| 237A | sprocket |
| 237B | sprocket |
| 238 | vertical support |
| 239 | chain drive |
| 240 | screen filter |
| 241A | flow port |
| 241B | flow port |
| 242 | starter motor |
| 243 | motor mount |
| 244 | sheave |
| 245 | sheave |
| 246 | sheave |
| 247 | sheave support |
| 248 | lever |
| 249 | belt |
| 250 | cylindrical canister wall |
| 251 | circular end wall |
| 252 | circular end wall |
| 253 | clutch |
| 254 | arrow |
| 255 | shaft flow channel |
| 256 | transverse passageway |
| 257 | arrow |
| 258 | turbine |
| 259 | clam shell |
| 260 | left ring gear |
| 261 | left sun gear |
| 262 | planet gear |
| 263 | right ring gear |
| 264 | right planet gear |
| 265 | reaction blade |
| 266 | externally threaded portion |
| 267 | lock nut |
| 268 | lock ring |
| 269 | bolted connection |
| 270 | pump blade |
| 271 | turbine |
| 272 | planet gear plate |
| 273 | turbine blade |
| 274 | micro-bubble |
| 275 | combustion of bubble |
| 276 | arrow |
| 277 | arrow |
| 278 | arrow |
| 279 | pump blade wall |
| 280 | nozzle thrust jet |
| 281 | planet gear shaft |
| 282 | fastener |
| 283 | sleeve |
| 284 | bearing |
| 285 | left clamshell half |
| 286 | right clamshell half |
| 287 | bearing |
| 288 | sleeve |
| 289 | right sun gear |
| 290 | fastener |
| 291 | flow channel |
| 292 | plate |
| 293 | flow port |
| 294 | bore |
| 295 | channel |
| 296 | arrow |
| 297 | reservoir wall |
| 298 | reservoir |
| 299 | planet gear mount |
| 300 | chamber |
| 301 | plate |
| 302 | bearing |
| 303 | expander plate |
| 304 | port |
| 305 | channel |
| 306 | chamber |
| 307 | chamber |
| 308 | channel |
| 309 | tube |
| 310 | peripheral member |
| 311 | bolted connection |
| 312 | nozzle |
| 313 | annular space |
| 314 | ports |
| 315 | combustion engine |
| 316 | housing |
| 317 | reservoir section |
| 318 | cover |
| 319 | interior |
| 320 | fluid |
| 321 | fluid level |
| 322 | feet |
| 323 | flange |
| 234 | flange |
| 325 | beam |
| 326 | beam |
| 327 | bearing |
| 328 | bearing |
| 329 | drive shaft |
| 330 | starter end portion |
| 331 | fluid inlet end portion |
| 332 | fluid outlet jet |
| 333 | chamber |
| 334 | rotary fluid coupling |
| 335 | flow inlet line |
| 336 | fluid control valve |
| 337 | flow outlet line |
| 338 | pump |
| 339 | suction line |
| 340 | outlet port |
| 341 | power take off |
| 342 | sprocket |
| 343 | sprocket |
| 344 | chain drive |
| 345 | bypass flow line |
| 346 | flow port |
| 347 | starter motor |
| 348 | motor mount |
| 349 | sheave |
| 350 | sheave |
| 351 | sheave |
| 352 | sheave support |
| 353 | lever |
| 354 | belt |
| 355 | cylindrical wall |
| 356 | circular end wall plate |
| 357 | circular end wall plate |
| 358 | clutch |
| 359 | arrow |
| 360 | shaft flow channel |
| 361 | radial passageway |
| 362 | annular chamber |
| 363 | hub |
| 364 | central opening |
| 365 | opening |
| 366 | housing inner surface |
| 367 | combustion site |
| 368 | hub |
| 369 | compression drive blades |
| 370 | angled thrust tube |
| 371 | clamshell housing |
| 372 | arrow |
| 373 | annular chamber |
| 374 | bearing |
| 375 | bearing |
| 376 | sun gear |
| 377 | hub |
| 378 | hub central opening |
| 379 | reaction blades |
| 380 | combustion channel blades |
| 381 | planet gear |
| 382 | central opening |
| 383 | outer surface |
| 384 | planet gear shaft |
| 385 | ring gear |
| 386 | arrow |
| 387 | arrow |
| 388 | arrow |
| 389 | arrow |
| 390 | arrow |
| 391 | arrow |
| 392 | arrow |
| 393 | arrow |

The foregoing embodiments are presented by way of example only; the scope of the present invention is to be limited only by the following claims.

1. A micro-combustion chamber torque transfer device comprising:
a) a housing with an interior that includes a fluid reservoir;
b) the reservoir having a fluid for combustion;
c) the housing having a mechanical mixer that generates minute bubbles in the fluid;
d) a drive shaft mounted on the housing and including a portion that extends into the housing interior;
e) a chamber mounted to the drive shaft for rotation therewith;
f) a torque generating system positioned within the chamber interior for transferring torque to the drive shaft when fluid combustion takes place within the chamber interior;
g) a circulation channel for supplying fluid from the reservoir to the torque generator along a continuous flow path;
h) the torque generating unit including at least two rotating members, each with vanes thereon, the respective vanes being closely positioned with a small gap therebetween so that when the two rotating members are rotated in a given rotational direction, combustion of material in the small bubbles occurs in and between the rotating members;
i) an input means for rotating the shaft; and
j) the respective vanes of the two rotating members being configured so that the rotating members rotate in opposite rotational directions when the input means is activated causing fluid to flow to the vanes.

2. The device of claim 1, wherein the torque generating unit includes a gear arrangement for transferring torque from one of the rotating members to the chamber and drive shaft.

3. The device of claim 2, wherein the gear arrangement includes one or more planetary gear sets.

4. The device of claim 1, wherein the fluid has a fluid surface within the reservoir and the chamber is positioned above the fluid surface.

5. The device of claim 1, wherein the fluid is preliminarily pumped through the circulation channel when the starter is activated.

6. The device of claim 1, wherein the bubble forming means includes but not limited to a member mounted for rotation on the drive shaft.

7. The device of claim 1 wherein the vanes of at least one of the rotating members are curved.

8. The device of claim 7, wherein the vanes of at least one of the rotating members includes circumferentially, regularly spaced apart vanes mounted on a circular body.

9. The device of claim 7, wherein the vanes of each of the rotating members includes circumferentially, regularly spaced apart vanes mounted on a circular body.

10. A micro-combustion chamber torque transfer device comprising:
a) a housing that includes a pump having a fluid reservoir containing a combustible fluid;
b) a rotating drive shaft rotatably mounted on the housing and having a central flow bore therein;
c) a high pressure chamber fixedly attached to the drive shaft for rotation therewith;
d) a clam shell having left and right halves, the left clam shell including the high pressure chamber containing:
(i) a plurality of pump blades rotatably journalled to the drive shaft;
(ii) a reaction blades unit including one or more reaction blades rotatably journalled on the drive shaft;
(iii) a turbine rotatably journalled on the drive shaft and containing one or more combustion channel blades;
(iv) a transmission gear set including a right ring gear fixedly attached to a right end plates for rotation therewith, a right sun gear fixedly attached to the right clam shell for rotation therewith, one or more planet gears, each planet gear rotatably journalled turbine at a location radially intermediate the sun gear and the ring gear and in meshing engagement with the sun gear and the ring gear;
(v) the gear set including a left end plurality of planet gears rotatably mounted on the plate end plate and a sun gear attached to the reaction blades and a left ring gear attached to the pump blades, wherein the right sun gear is affixed to the right clam shell;
e) means for circulating the fluid through the high pressure chamber;
f) means for aerating the fluid so that it contains small bubbles with a mixture of oxygen; and
g) the impulse drive blades and combustion channel blades being so configured and spaced and with a small gaps therebetween to compress the small bubbles at an interface, combustion area next to the gap between the impulse drive blades and combustion channel blades, and causing a torque to be transferred to the drive blades and drive shaft.

11. The device of claim 10, wherein the housing completely surrounds the high pressure chamber.

12. The device of claim 10, wherein the chamber includes a pair of end plates affixed to the shaft for rotation therewith.

13. The device of claim 10, wherein an air (gas) bubble is combusted.

14. The device of claim 10, wherein the drive shaft has a fluid conveying bore and a transverse port that exits the shaft between its end portions.

15. The device of claim 10, wherein the aerating means includes a rotating member that is carried by the shaft and at least one outlet flow jet that sprays fluid from the chamber and upon the rotation member during use.

16. The device of claim 10, wherein further comprising a rotational input for rotating the shaft.

17. The device of claim 10, wherein the rotational input rotates the shaft at a rotational speed sufficient to initiate combustion of the fluid at the interface.

18. The device of claim 12, wherein the ring gear is affixed to one of the end plates.

19. The device of claim 13, wherein the compression drive unit is affixed to the end plate and shaft for rotation therewith.

20. A micro-combustion torque transfer device engine comprising:
a) a housing with an interior that includes a fluid reservoir;
b) the reservoir having a fluid for combustion;
c) means for forming bubbles in the fluid;
d) a drive shaft mounted on the housing and including a portion that extends into the housing interior;
e) a chamber mounted on the drive shaft for rotation therewith;
f) torque transferring means positioned within the chamber interior for transferring torque to the drive shaft when fluid combustion takes place within the chamber interior;
g) a circulation channel for supplying fluid from the reservoir to the torque transferring unit along a continuous flow path;
h) the torque transferring unit including at least two rotating members, that are so configured and so closely positioned with respect to each other that when the two rotating members are rotated, combustion of material in the small bubbles occurs at a combustion gap in between the two rotating members so that the bubbles expand;
i) rotational input means for rotating the drive shaft;
j) the respective vanes of the two rotating members being so configured that torque is transferred to the drive shaft from the torque transferring unit when the bubbles expand.
